(19) United States
(12) Patent Application Publication
(10) Pub. No.: US 2004/0147300 A1
(43) Pub. Date: Jul. 29, 2004

(54) Gaming device having an animated figure

(75) Inventors: Jerald C. Seelig, Absecon, NJ (US); Lawrence M. Henshaw, Hammonron, NJ (US)

Correspondence Address: IAN F. BURNS & ASSOCIATES, 1575 DELUCCHI LANE, SUITE 222, RENO, NV, 89502, US

(73) Assignee: Atlantic City Coin & Slot Service Company, Inc., Pleasantville, NJ

(21) Appl. No.: 10/757,613

(22) Filed: Jan. 13, 2004

Related U.S. Application Data
(63) Continuation-in-part of application No. 10/309,736, filed on Dec. 3, 2002.
Application No. 10/309,736 is a division of application No. 09/894,198, filed on Jun. 27, 2001, now Pat. No. 6,537,152.
(60) Provisional application No. 60/241,383, filed on Oct. 17, 2000.
(60) Provisional application No. 60/503,302, filed on Sep. 15, 2003.

(51) Int. Cl. A63F 13/00

(52) U.S. Cl. 463/1; 463/16

(57) ABSTRACT

The present invention relates to an animated gaming system that includes a housing configured to hold gaming components, a game controller, and a display area located in the housing that may have a plurality of prize displays located thereon. The prize displays may display game related indicia. The game controller is configured to control game functions and components, present a game to a player, and randomly determine a game outcome. The animated gaming system may also include an animated figure having at least one animated element movable between at least a first and a second position. In at least one position, the animated element is proximate at least one prize display. The animated figure also comprises an actuator configured to move the animated element in response to signals from the game controller. The animated figure can be made to appear to indicate at least one prize display.

### CROSS REFERENCES TO RELATED APPLICATIONS

This application is a continuation-in-part application of U.S. application Ser. No. 10/309,736, filed Dec. 3, 2002. That application is a divisional application of U.S. application Ser. No. 09/894,198, now U.S. Pat. No. 6,537,152, filed Jun. 27, 2001, which claims priority of provisional patent application Ser. No. 60/241,383, filed on Oct. 17, 2000. This application also claims priority of provisional U.S. patent application Ser. No. 60/503,302, filed on Sep. 15, 2003. The aforementioned applications are hereby expressly incorporated by reference in their entireties.

### BACKGROUND

1. Field of Invention

The present invention relates to a gaming system and method having an animated figure. More particularly, the gaming system comprises a three-dimensional animated figure that indicates a prize.

2. Description of Related Art

Gaming Devices

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number. The random number may then be compared to a pre-defined table to determine the outcome of the event. If the random number falls within a certain range of numbers on the table, the player may win a prize. The table may also contain display information that allows the gaming device to generate a display that corresponds to the outcome of the game. The gaming device may present the outcome of the game on a large variety of display devices, such as mechanical spinning reels or video screens.

Bonus Prizes

Some gaming devices award bonuses in addition to prizes that are awarded in the primary game. A bonus can be defined as an additional prize that is awarded to the player when a pre-defined event occurs. An example of a bonus game can be found in U.S. Pat No. 5,848,932 issued to Adams. One of the gaming devices described in this document comprises three spinning reels and a spinning wheel bonus display. When predetermined indicia are displayed on the spinning reels of the primary game, the wheel can be activated to indicate a bonus prize. The bonus prize is awarded in addition to any prizes awarded in the primary game.

Generally, bonus prizes are offered in order to increase the excitement and enjoyment experienced by players. This attracts more players to the game and encourages players to play longer. When gaming devices attract more players and the players play longer, gaming devices tend to be more commercially successful relative to other gaming devices.

Games Having Animated Characters

It is well known that games of chance, such as slot machines, may have an animated character that operates in conjunction with the game of chance. For example, in Slot Machines, by Marshall Fey, a slot machine called “Shoot the Bear” is described in which a bear that stands up and growls when a jackpot is hit.

More generally, gaming devices having animated characters are well known. For example, in U.S. Pat. No. 4,799,678, hereinafter the “'678 patent”, a game device is described that interacts with an animated character to simulate a game show.

### SUMMARY OF AT LEAST ONE EMBODIMENT OF THE INVENTION

Advantages of One or More Embodiments of the Present Invention

The various embodiments of the present invention may, but do not necessarily, achieve one or more of the following advantages:

provide a gaming device having an animated figure that identifies a prize;

provide a control system for controlling the actions of an animated gaming system;

provide a control system for controlling the actions of an animated display system;

provide a housing having at least one symbol that represents a prize;

provide an animated gaming device that may be used as a stand-alone game;

provide an animated gaming device that may be used in combination with another gaming device;

provide an animated gaming device that may be engaged after a bonus-triggering event;

provide a housing having a plurality of prizes that are identified by the animated figure; and

provide a gaming device having an animated figure that requires little maintenance.

These and other advantages of the present invention may be realized by reference to other portions of the specification, claims, and abstract.

Brief Description of at Least One Embodiment of the Invention

In certain embodiments, the present invention relates to an animated gaming system that includes a housing configured to hold gaming components, a game controller, and a display area located in the housing that may have a plurality of prize displays located thereon. The prize displays may display game related indicia. The game controller is configured to control game functions and components, present a game to a player, and randomly determine a game outcome. The animated gaming system may also include a physical animated figure having at least one animated element movable between at least a first and a second position. In at least one position, the animated element is proximate at least one prize display. The physical animated figure also comprises an actuator configured to move the animated element in response to signals from the game controller. The animated figure can be made to appear to indicate at least one prize display.

In at least one embodiment, the present invention relates to a method for operating a gaming device. A player may be allowed to place a wager and play a game of chance having a random game outcome. The random game outcome is determined using a controller. At least a portion of a moveable animated figure is moved on a display area of a housing by an actuator in response to a signal received from the controller. The moveable animated figure is used to indicate a prize display corresponding to the random game outcome.

The above description sets forth, rather broadly, the more important features of the present invention so that the detailed description of certain embodiments of the invention that follows may be better understood and the contributions of the present invention to the art may be better appreciated. There are, of course, additional features of the invention that will be described below and will form the subject matter of the claims. In this respect, before explaining at least certain embodiments of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Certain embodiments of the present invention are shown in the accompanying drawings wherein:

FIG. 1A is substantially a front perspective view of a gaming device having an animated figure that identifies a first prize.

FIG. 1B is substantially a block diagram of a system for controlling the gaming device of FIG. 1A.

FIG. 1C is substantially a front perspective view of the gaming device of FIG. 1A in which a first animated element is moved to identify a second prize.

FIG. 1D is substantially a front perspective view of the gaming device of FIG. 1A in which the animated figure is rotated and a second animated element is moved to identify a third prize.

FIG. 2A is substantially a flow chart of the operation of the gaming device shown in FIGS. 1A through 1D.

FIG. 2B is substantially a more detailed flow chart of the operation of the gaming device shown in FIGS. 1A through 1D.

FIG. 3 is substantially a front perspective view of a gaming system that includes a first gaming device and a second gaming device having an animated figure.

FIG. 4 is substantially a flow chart of the operation of the gaming system in FIG. 3.

FIG. 5A is substantially a front elevational view of a gaming system that includes a first gaming device and second gaming device having an animated figure configured to dispense a prize.

FIG. 5B is substantially a front elevational view of the gaming system of FIG. 5A in which the animated figure identifies a first prize.

FIG. 5C is substantially a front elevational view of the gaming system of FIG. 5A in which the animated figure identifies a second prize.

FIG. 6 is substantially a front elevational view of an animated gaming system according to the present invention having an animated figure that may have multiple animated elements.

FIG. 7 is substantially a side elevational view of one possible actuating device for the animated gaming system of FIG. 6.

FIG. 8A is substantially a front elevational view of an animated gaming system that may indicate more than one prize display and that may include a changeable background section.

FIG. 8B is substantially a side elevational view of one possible actuating mechanism for the animated gaming system of FIG. 8A.

FIG. 8C is substantially a front perspectvie view of one possible display device for an animated gaming system according to the present invention.

FIG. 8D is substantially a front perspective view of one possible display device for an animated gaming system according to the present invention.

FIG. 9A is substantially a front elevational view of an animated gaming system of the present invention having an animated figure that is both inside and outside a display covering.

FIG. 9B is substantially a front elevational view of an alternate embodiment of the animated gaming system of FIG. 9A.

FIG. 10A is substantially a front elevational view of one embodiment of an actuating mechanism for use with the animated gaming system of FIG. 9A.

FIG. 10B is substantially front elevational view one embodiment of an actuating mechanism for use with the animated gaming system of FIG. 9A.

FIG. 11 is substantially a front elevational view of an animated gaming system that may indicate more than one prize display.

FIG. 12 is substantially a front elevational view of an animated gaming system according to the present invention having a moveable animated figure having an animated element.

FIG. 13 is substantially a side elevational view of one possible actuating mechanism for the animated gaming system of FIG. 12.

FIG. 14 is substantially an alternate front elevational view of the animated gaming system of FIG. 12.

FIG. 15 is substantially a front elevational view of an animated gaming system of the present invention having a moveable animated figure that may have a plurality of movement modes.

FIG. 16 is substantially a front elevational view of an animated gaming system of the present invention having an animated figure with a plurality of animated elements.

FIG. 17 is substantially an alternate front elevational view of the animated gaming system of FIG. 16.

FIG. 18A is substantially a front elevational view of an actuating mechanism that may be used with the animated figure of FIG. 16.

FIG. 18B is substantially a side elevational view of an actuating mechanism that may be used with the animated figure of FIG. 16.

FIG. 18C is substantially a front elevational view of an actuating mechanism that may be used with the animated figure of FIG. 16.

FIG. 18D is substantially a front elevational view of an actuating mechanism that may be used with the animated figure of FIG. 16.

FIG. 18E is substantially a front elevational view of an actuating mechanism that may be used with the animated figure of FIG. 16.

FIG. 19 is substantially a front elevational view of an embodiment of an animated gaming system of the present invention having an animated figure that may have a plurality of animated elements.

FIG. 20 is substantially a front elevational view of an embodiment of an animated gaming system of the present invention having an animated figure that may have a plurality of animated elements.

FIG. 21 is substantially a front elevational view of an embodiment of an animated gaming system of the present invention having an animated figure that may have a plurality of animated elements.

FIG. 22 is substantially a front elevational view of an embodiment of an animated gaming system of the present invention having an animated figure and indicators that may be hidden from a player's view.

FIG. 23 is substantially a front elevational view of an embodiment of an animated gaming system of the present invention having an animated figure that may have a plurality of animated elements.

FIGS. 24A-24F are substantially side elevational views of actuating mechanisms that may be used with the animated figure of FIG. 23.

### DESCRIPTION OF AT LEAST ONE EMBODIMENT OF THE PRESENT INVENTION

In the following detailed description of certain embodiments of the invention, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

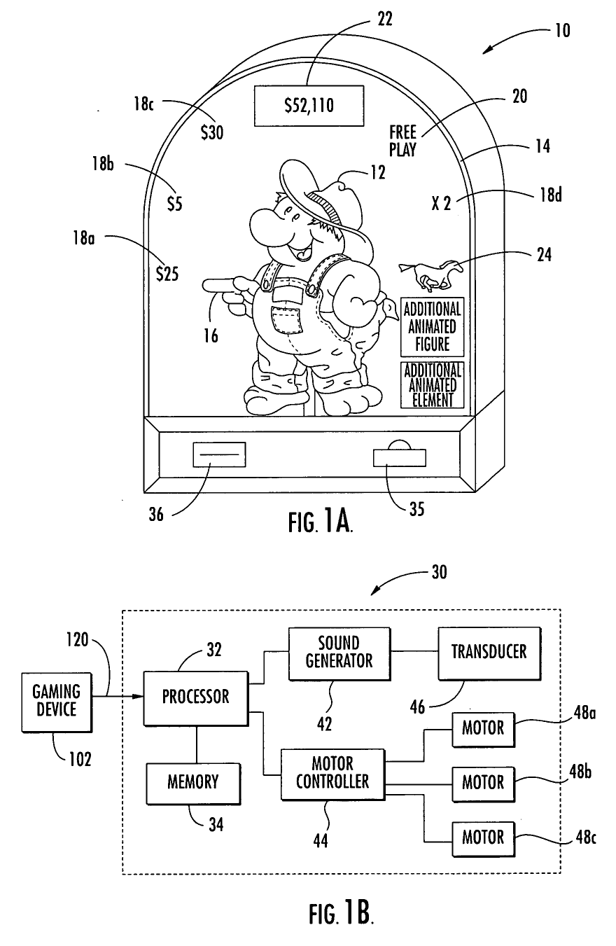

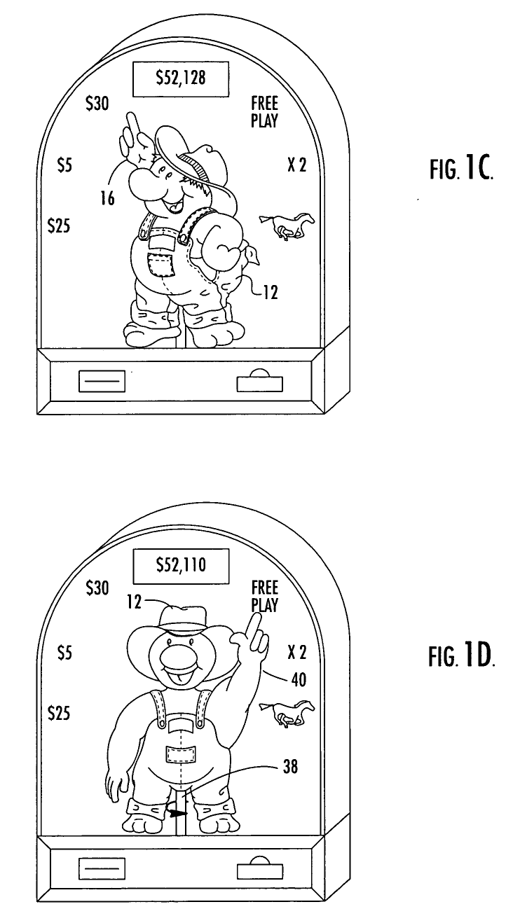

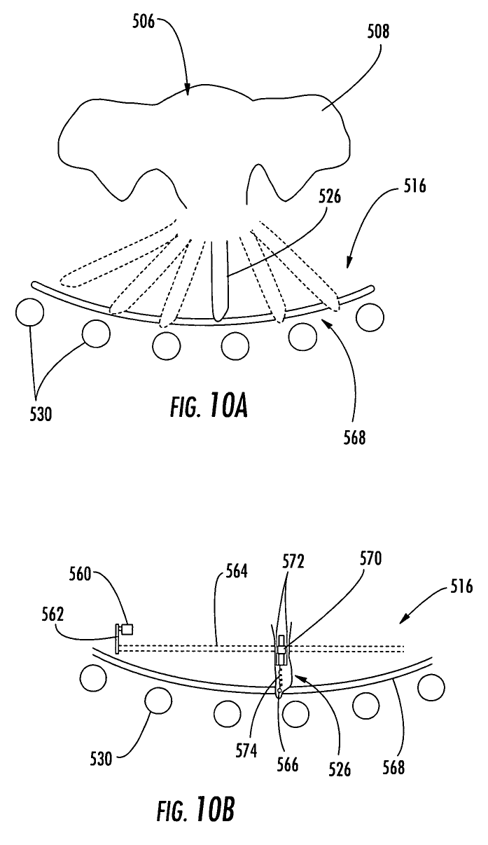

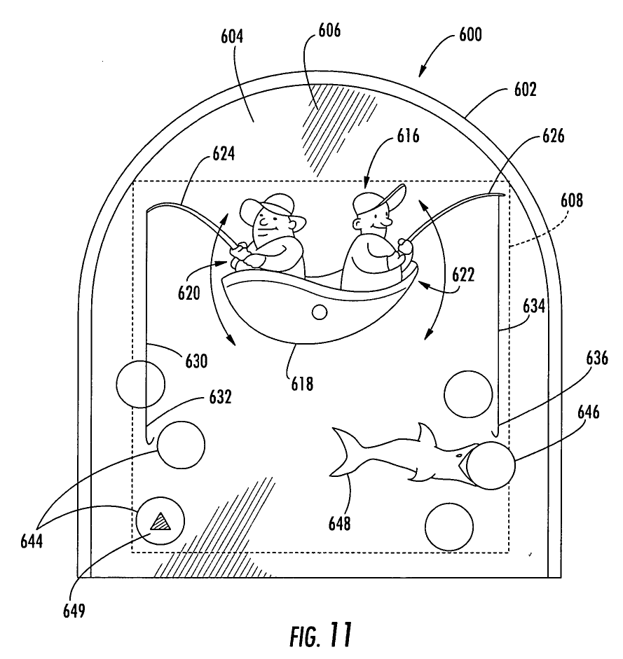

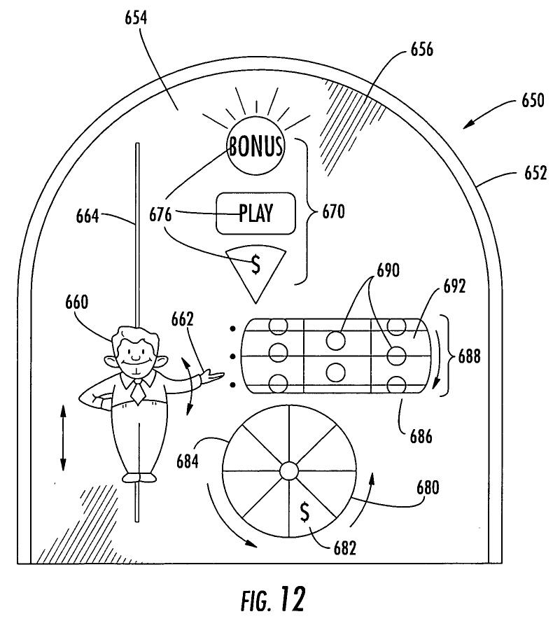

The present invention comprises an animated gaming system, an example of which is illustrated in FIG. 1A. The animated gaming system is indicated by reference number 10 and it comprises an animated FIG. 12 that is operatively coupled to a housing 14. Preferably, animated FIG. 12 comprises one or more robotic components in communication with a control system. Housing 14 may include a plurality of game symbols or prize displays. The game symbols may be used in communicating the outcome of the game to a player and the prize displays may be used to communicate one or more prizes that are to be awarded to a player. In operation, the movements of animated FIG. 12 are determined by the control system. In one embodiment, the animated figure identifies a prize located on the housing 14. The animated gaming system 10 may be operated as a stand-alone machine or in combination with another gaming device. The animated gaming system 10 and some of its variations are described in further detail below.

### Animated Gaming System

Referring again to FIG. 1A, the animated gaming system 10 of the present invention includes a housing 14, an animated FIG. 12, and an animated element 16. Housing 14 may include a variety of symbols that represent a variety of prizes. The symbols displayed on the housing may include, without limitation, numbers, letters, and various other shapes.

In the embodiment in which prizes are displayed, there may be a large variety of different kinds of prizes. For example, the prizes may be monetary amounts 18a through 18c, a progressive networked prize 22, which is a prize created by an array of networked games, an additional opportunity to play a game 20, a multiplier 18d, which is multiplied with a base amount, or a good or service 24, such as an automobile or horse. Animated FIG. 12 preferably has a three-dimensional form having one or more robotic components that may be controlled by a control system. Animated FIG. 12 includes at least one animated element 16 that identifies or points to one or more of the symbols displayed on the housing 14.

Animated FIG. 12 may be in the form of a realistic or fictional animal. Alternatively, animated FIG. 12 may have human features and be human-like, or be in the form of a cartoon character or the like. Furthermore, animated FIG. 12 may be a relatively simple figure that generates limited sounds and provides limited motion. Alternatively, the animated figure could be a sophisticated system having the ability to speak and to make very precise and complex movements. It shall be appreciated by those skilled in the art having the benefit of this disclosure that the description of “animated figure” includes robots that are commonly used in other industries and are commonly available in the marketplace. Such robots and the sources for these robots are described in the book entitled Illusion of Life Lifelike Robots, by Gene William Poor, published in 1991 by Creative Learning Systems, Inc. of San Diego, Calif.

Referring to FIG. 1B, there is shown a block diagram of one possible control system 30 that controls the operations of animated FIG. 12. The boundary conditions for control system 30 are provided to teach some of the functions of control system 30 and are not intended to restrict the method and type of control system used. By way of example, animated FIG. 12 is controlled by processor 32. Additionally, processor 32 is configured to communicate with a memory 34. Memory 34 may store software programs or may provide caching functionality. Memory 34 may comprise flash memory, EEPROM, EPROM, ROM, SRAM, DRAM or other forms of memory.

In operation, animated gaming system 10 may be activated by insertion or transfer of value into a value receiving device 35, which is in communication with processor 32. Value receiving device 35 may receive a variety of different kinds of media that represent or transfer value, including coins, paper currency, coupons, tickets, vouchers, credit cards, debit cards, electronic credits, or any other such transactional media.

In one embodiment, processor 32, in combination with memory 34 and random number generator software, is configured to generate a random number. In an alternative embodiment, an integrated circuit may be configured to generate a random number. The random number generator produces a random or pseudo-random number for each game of animated gaming system 10. The outcome of the gamed played on animated gaming system 10 may be determined by comparing the random number to a table of outcomes stored in a memory (which may be memory 34) and accessed by processor 32.

The random number may be used to determine the prize to be awarded according to a table, which may be referred to as a “pay table.” A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, U.S. Pat. No. 5,456,465, issued to Durham, and U.S. Pat. No. 5,823,874, issued to Adams.

The combination of processor 32 and memory 34 causes animated gaming system 10 to display the outcome of the game that corresponds to the outcome of the random number generator and table. Animated gaming system 10 may operate in many other ways and still achieve the objects of the present invention.

A simple pay table may appear as follows:

| Random | Location | Amount |
|---|---|---|
| Number | Number | Paid |
| 0.00 to 0.03 | 1 | $25.00 |
| 0.04 to 0.20 | 2 | 0.00 |
| 0.21 to 0.26 | 3 | $5.00 |
| 0.27 to 0.76 | 4 | 0.00 |
| 0.77 to 0.82 | 5 | $30.00 |
| 0.83 to 0.84 | 6 | Progressive |
| 0.85 to 0.89 | 7 | Free Play |
| 0.90 to 0.95 | 8 | Multiplier |
| | | X2 |
| 0.96 to 1.00 | 9 | Other |
| | | Symbol |

For example, if the random number generator produced a 0.03 value, the animated element 16 would move to location number 1, which identifies the $25.00 prize as shown in FIG. 1A. Referring to FIG. 1C, if the random number generator produced a 0.78 value, the animated element may be moved to location 5 according to the table above and displays the $30 prize shown. Referring to FIG. 1D, if the random number generator produced a 0.85 value, then the animated FIG. 12 may be rotated about axis 38 and a second animated element 40 may be moved to location 7 that identifies the “free play” prize.

The present invention is not limited to the example pay table shown. A variety of different pay tables and prizes may be used. For each different housing 14, a new pay table identifying the appropriate location may be loaded into processor 32 and/or memory 34. Housing 14 may also include changeable display devices, such as meter 22, which allow many different kinds of prizes to be displayed in the same location. Changeable display devices may comprise LED, LCD, video displays, etc.

In one embodiment of the present invention, prizes are awarded in the form of tickets, vouchers, or coupons. In this embodiment, the tickets, vouchers, and coupons may be dispensed using an internally or externally mounted dispenser 36 (see FIG. 1A). Such dispensers are well known in the art. Additionally, a coin dispenser (not shown), well known in the art, may by used.

In an alternative embodiment, animated gaming system 10 includes an additional plurality of animated figures (not shown) within the same housing. The plurality of animated figures may be managed by control system 30. The plurality of animated figures may include a plurality of animated FIGS. 12 within one housing 14 wherein each of the plurality of animated figures identifies a symbol that, in combination with the output from each of the animated figures, may result in a player being awarded a prize.

### Control System

The control system preferably provides one or more outputs to control various game functions and components to carry out the functions of animated gaming system 10. Referring back to FIG. 1B, animated FIG. 12 preferably includes a processor 32 in communication with a sound generator 42 and a motor controller 44. Control system 30 manages the signals that control the operations of animated FIG. 12. The boundary conditions for control system 30 describe some of the functions of control system 30. By way of the example, animated FIG. 12 is controlled by processor 32 that is operatively coupled to memory 34. Memory 34 provides storage for various software programs or subroutines or may provide caching functionality. Although not shown, flash memory, EEPROM, EPROM, ROM, SRAM, DRAM, and other forms of memory or any combination thereof may be used.

Sound generator 42 may provide local storage for a variety of different sounds. The variety of different sounds may be downloaded from processor 32 and memory 34 or the sounds may be pre-programmed in sound generator 42. Sound generator 42 communicates output signals to a transducer 46, such as a speaker, which generates an audible output.

Motor controller 44 may be configured to provide local storage for a variety of different commands that control motors 48a, 48b, and 48c. Motor controller 44 may receive commands from processor 32 or may have a plurality of commands stored locally in motor controller 44. Each motor 48a, 48b, and 48c may control and cause movement in one or more animated elements, such as an arm, finger, leg, or mouth. Although reference is made to motors, it is to be understood that other actuators, such as hydraulic or pneumatic devices, may be used in place of motors.

In a simple illustrative embodiment, animated FIG. 12 comprises only a portion of an animal such as the head. When control system 30 generates the appropriate output, the mouth of animated FIG. 12 is moved according to motor controller 44 and a sound is generated according to sound generator 42.

In a more complex illustrative embodiment, animated FIG. 12 may take the shape of a lifelike human or cartoon character capable of sophisticated movements and speech. Animated FIG. 12 may be programmed to frown or cry and then console the gaming device player upon an indication that the player did not win a prize. Alternatively, animated FIG. 12 could be programmed to jump up and down and sing or scream such statements as, “You have won,” or “You are a winner,” or the like. It may also be possible to have animated FIG. 12 do tricks such as somersaults or to throw candy or other safe projectiles at the slot machine player.

### Method for Operating the Animated Gaming System

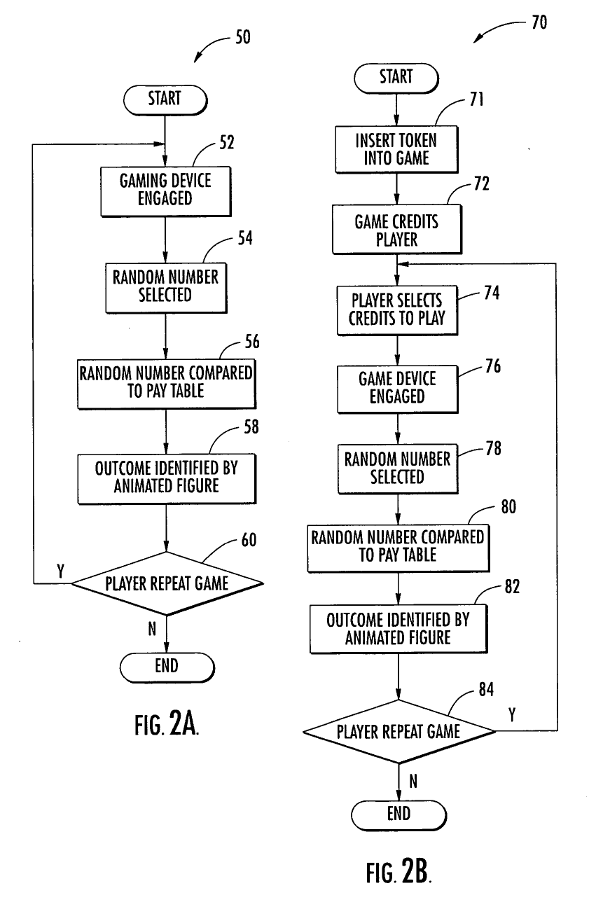

Referring to FIGS. 1A and 2A, an example of a method 50 for operating animated gaming system 10 will now be described. At step 52, animated gaming system 10 may be engaged using a variety of methods. For example, a player may insert currency into value receiver device 35.

At step 54, method 50 proceeds to select a random number. It shall be appreciated by those skilled in the art that the use of a random number generator is well known in the art of gaming equipment. At step 56, method 50 compares the random number to a table to generate an outcome as described above. The outcome may be determined by another gaming device in communication with animated gaming system 10. Preferably, the table includes a location number that is associated with a range of random numbers. Method 50 then proceeds to step 58.

At step 58, the outcome is identified and displayed by animated FIG. 12. Using the table identified above, the location number is communicated to motor controller 44 and sound generator 42. Motor controller 44 and sound generator 42 generate the appropriate signals that are communicated to motors 48a through 48c and transducer 46, respectively. One of motors 48a through 48c moves animated element 16 to communicate an outcome of the game. Method 50 then proceeds to decision 60.

At decision 60, it is determined whether to continue the game or not. If it is decided that the game is to be continued, method 50 proceeds to step 52 and the animated gaming device is re-engaged. If it is decided that the game is not to be continued, the game is ended.

Referring to FIG. 2B there is shown a more detailed method 70 for engaging the animated gaming system of FIG. 2A. Steps 71, 72, and 74 describe the engagement of the animated gaming system described in FIG. 2A.

At step 71, method 70 provides for the insertion of tokens into the animated gaming system. The insertion of tokens may be physical or may be electronic. Physical tokens include coins, paper currency, coupons, magnetic stripe cards, or other such devices. Electronic tokens are generated by a network or may be generated by a storage media, such as a magnetic stripe card or smart card. The tokens are communicated to a value receiving device 35 as described above. Method 70 then proceeds to step 72.

At step 72, method 70 provides for the crediting of a player. The token is converted to credits by processor 32. The credits may be transferred or stored on the animated gaming system. Method 70 then proceeds to step 74.

At step 74, method 70 provides for permitting the player to select how many credits to play (or wager) on animated gaming system 10. For games of chance, the credits played may be used to determine the size of the payment to the player, should the player be entitled to a prize. However, it shall be appreciated by those skilled in the art that the present animated gaming system is not confined to games of chance. Method 70 then proceeds to step 76.

Steps 76, 78, 80, and 82 are substantially similar to steps 52, 54, 56 and 58, respectively. Therefore, the prior discussion of the functions performed in these steps is incorporated by reference. Method 70 then proceeds to decision 84.

At decision 84, it is determined whether to continue the game or not. If it is decided that the game is to be continued, method 70 proceeds to step 74 and the animated gaming device is re-engaged after the player selects the credits to play. If it is decided that the game is not to be continued, the game is ended.

### Gaming System

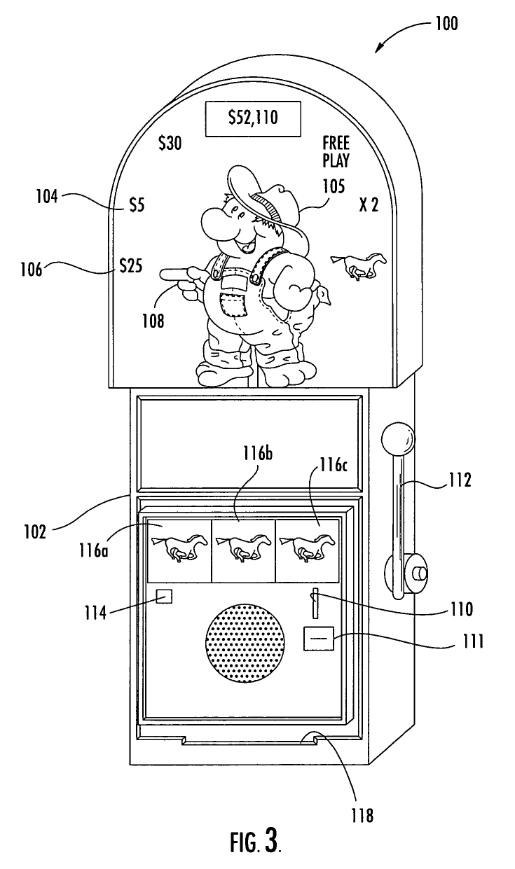

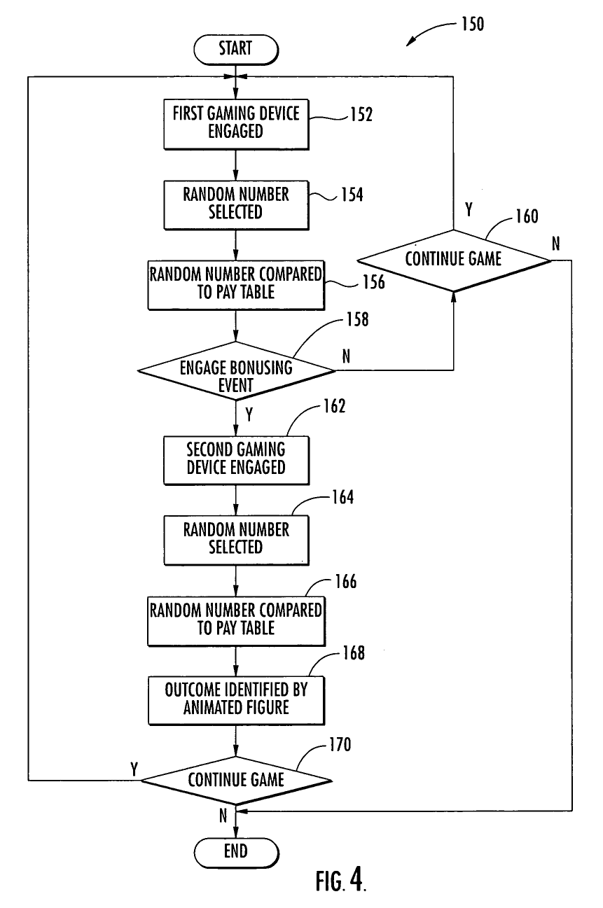

In an alternative embodiment, animated gaming system 10 is used in combination with another gaming device and this combination is referred to as gaming system 100 and is illustrated in FIG. 3. Gaming system 100 includes a first gaming device 102, an animated gaming system 104 having an animated FIG. 105 and a housing 106. First gaming device 102 may be a traditional gaming device, such as a slot machine or video game. Animated FIG. 105 preferably has a three-dimensional form and includes an animated element 108. Two-dimensional representations could also be used. Animated element 108 may be configured to identify a prize. Housing 106 houses animated FIG. 105, which is operatively coupled to first gaming device 102. It shall be appreciated by those skilled in the art of gaming design that housing 106 may include a variety of symbols that may represent a variety of prizes, such as the prizes described above.

In a presently preferred embodiment, first gaming device 102 is a game, such as a slot machine of general conventional construction, and preferably includes a coin slot 110, a card reader 111, and a lever arm 112. Most slot machines also include a push button 114 that can be activated in order to initiate play in lieu of pulling lever arm 112. First gaming device 102 also includes a window that displays spinning reels 116a, 116b, and 116c. First gaming device 102 may be either of the conventional mechanical type with rotating wheel or of the electronic type that simulates rotating wheels and that includes one or more electronic video type displays. The prizes may be awarded with a coin dispenser 118, a voucher printer, by an attendant, or by other methods known in the art. In at least one preferred embodiment, first game device 102 may be an S Plus model gaming device manufactured by International Game Technology in Reno, Nev.

Although the use of a slot machine is a presently preferred type of first gaming device 102 for gaming system 100, it should be apparent to those skilled in the art that other types of games of chance, such as poker machines, blackjack machines, keno machines, and the like, may also be used. It must be understood, therefore, that the description contained herein concerning the use of a slot machine is by way of example only. Regardless of the type of game of chance or gaming machine being utilized, a slot machine 102 or other gaming machine or combination thereof may be associated with animated gaming system 104.

Referring back to FIG. 1B, an electrical output line 120 from first gaming device 102 extends from first gaming device 102 and is adapted to carry the output signal from first gaming device 102 to animated FIG. 105. This output signal is intended to be representative of a particular condition of first gaming device 102. The output signal communicated from output line 120 is communicated to processor 32, which processes signals that control transducer 46 and motors 48a, 48b, and 48c that control animated element 108. For example, a particular signal may appear on output line 120 indicating that a particular event has occurred, such as the insertion of a unique coin or that multiple coins have been played. Or a signal may represent the fact that a particular button (not shown) has been activated. In addition, an appropriate signal could appear on output line 120 indicating that the slot machine wheels have stopped and that the player did not win anything or that the wheels have stopped and that the slot machine player has won. A different signal could obviously also appear depending on the amount that has been won. As should be readily apparent, a substantial number of different signals could appear individually or in combination on output line 120 indicating any one or more of a large number of different conditions of play of first gaming device 102.

Preferably, output line 120 is configured to communicate a bonus-activating event. This event may be the result of many different types of events. For example, a bonus-activating event may comprise displaying a particular symbol, such as a “bonus” symbol, or combination of symbols, such as three “horse” symbols, on reels 116a, 116b, and 116c. If the game being played is poker based, the bonus-activating event may be an occurrence of a certain hand, such as a royal flush. Furthermore, a bonus-activating event may occur when a player accumulates a certain number of symbols or game outcomes over a certain number of separate game plays. For example, a bonus-activating event may occur when the player receives three “bonus” symbols during a period of time. The bonus-activating event may be based on an external event. For example, a bonus-activating event may occur when a group of players obtain a certain result.

Preferably, the gaming device of the present invention comprises an animated FIG. 105 that is engaged by the bonus activating event described above. The control system for engaging the animated figure is described in the discussion regarding animated gaming system 10 in FIG. 1A. Additionally, animated gaming system 102 operates in a similar manner to animated gaming system 10 described above.

In operation, first gaming device 102 is played and animated gaming system 104 is activated when the bonus activating event occurs. The bonus activating event signal is communicated via output line 120 to the animated gaming control system. Animated element 108 is engaged and is used to identify the prize to be awarded to the player, as described above.

Additionally, animated gaming system 102 may include a combination of animated figures associated with a plurality of first gaming machines (not shown). Further still, animated gaming system 102 may be capable of directing its actions and sounds toward any one of the slot machine players playing one of the plurality of first gaming machines. It is also within the scope of the present invention to provide a single gaming system 100 having a plurality of animated figures that respond individually or in combination based on the play of a plurality of first gaming devices.

### A Method for Operating the Gaming System

Referring to FIG. 4, as well as FIGS. 3 and 1B, there is shown a method 150 for operating animated gaming system 100 of FIG. 3. Method 150 for operating animated gaming system 100 described above includes providing a first gaming device 102 and providing an animated gaming system 102 having an animated element 108.

At step 152, method 150 provides for engaging a first gaming device 102. First gaming device 102 may be engaged by the insertion of tokens that may be physical or may be electronic, as described above. The tokens may be communicated to a coin slot 1 10 that may act as a token receiving component. Once the token is received, the player is credited and permitted to play first gaming device 102. The player then selects the number of credits to play in first gaming device 102. Method 150 then proceeds to step 154.

At step 154, method 150 provides for selecting a random number. The random number is generated by a random number generator, which may be resident in a controller. It shall be appreciated by those skilled in the art that the provisioning for a random number generator is well known in the art of designing gaming equipment. Method 150 then proceeds to step 156.

At step 156, method 150 provides for comparing a random number to a table as described above. It shall be appreciated by those skilled in the art that the table may include a plurality of different combinations displayed by reels 116a, 116b, and 116c, which may be associated with a range of random numbers. Method 150 then proceeds to decision 158.

At decision 158, the bonus event is engaged. In an illustrative embodiment, the bonus event is engaged by first gaming device 102. Alternatively, the bonus event may be engaged by a separate component that is in communication with first gaming device 102. The results of the bonus event are communicated by output line 120 to animated gaming system 104. If the bonus event is not engaged, method 150 proceeds to decision 160. At decision 160, the player determines whether to continue playing first gaming device 102. If the bonus event is engaged, method 150 proceeds to step 162.

At step 162, animated gaming system 104 is engaged according to the bonus event communicated from output line 120 from first gaming device 102. Animated gaming system 104 includes a housing 106 that may have a variety of symbols identifying a variety of prizes. Output line 120 communicates with the animated control system having a processor 32 that controls the movements of one or more animated elements, such as animated element 108. Method 150 then proceeds to step 164.

At step 164, a second random number is selected. The random number may be generated by a second random number generator that is resident in a controller, which may comprise processor 32 and memory 34 of control system 30. The random number may also be generated by the first random number generator. Method 150 then proceeds to step 166.

At step 166, the second random number is compared to a pay table as described above. Preferably, the table includes a location number that is associated with a range of random numbers. Method 150 then proceeds to step 168.

At step 168, the outcome is identified and indicated by animated FIG. 105 or animated element 108. As described above, the location number is communicated to motor controller 44 and sound generator 42 by processor 32. Motor controller 44 and sound generator 42 generate the appropriate signals that are communicated to motors 48a through 48c and transducer 46, respectively. One of motors 48a through 48c moves animated element 108. Housing 106 has at least one symbol that represents at least one prize, as described previously. Animated element 108 is then used to identify the result of the outcome of the comparison in step 166. Method 150 then proceeds to decision step 170.

At decision 170, the player determines whether to continue playing the game. If the player decides to continue playing the game, the player is taken back to step 152 and the first gaming device is engaged. If the player decides not to continue playing the game, the game is ended. It is recognized that other, non-player, variables may be used to determine whether play is continued.

### A Gaming System Having an Animated Display

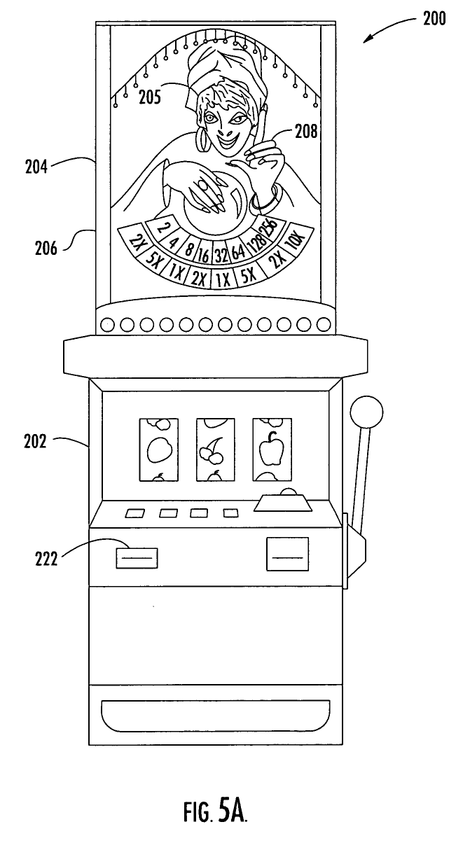

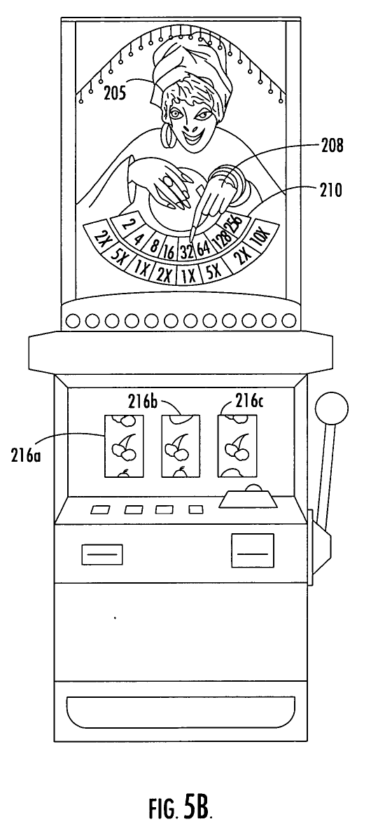

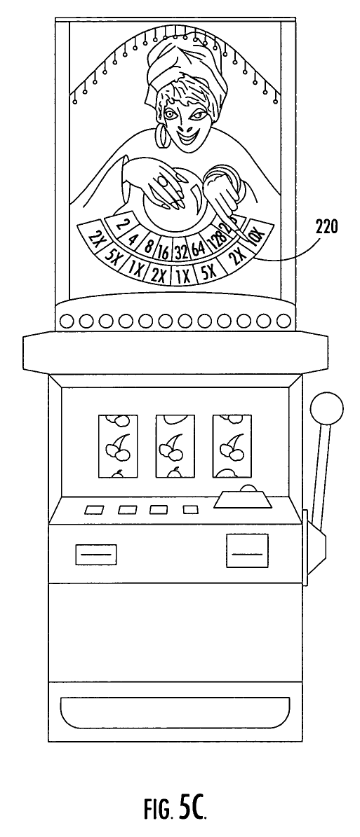

Referring to FIG. 5A there is shown an alternative gaming system 200 that communicates the output from a game device 202 to an animated display system 204. The gaming system 200 includes an animated display system 204 that is operatively coupled to gaming device 202. Preferably, game device 202 is a slot machine. However, it should be apparent to those skilled in the art that other games of chance may also be configured as game device 202. These other games of chance include poker machines, blackjack machines, keno machines, and the like.

Animated display system 204 includes animated FIG. 205, in this illustration a fortune teller, and housing 206. Animated FIG. 205 includes animated element 208 that is preferably configured to move along an x-axis, y-axis, and z-axis. Animated FIG. 205 is managed by control system 30 described above. However, in the preferred embodiment, control system 30 for animated FIG. 205 does not employ a pay table to determine the outcome that is displayed by animated FIG. 205. Rather, it is preferable that gaming device 202 communicates the output to animated FIG. 205 control system 30. Animated FIG. 205 then displays the prize that was determined by gaming device 202. By way of example, animated FIG. 205 may be configured so that animated element 208 identifies one of a plurality of prizes or identifies one of a plurality of bonuses.

By way of example, and not of limitation, animated element 208 is a hand that is controlled in the x-axis, y-axis, and z-axis by motors 48a, 48b and 48c, respectively. (See FIG. 1B). FIG. 5A shows the result of a player who has not won a prize due to the outcome of game device 202. Therefore, animated element 208 does not identify a prize.

Referring to FIG. 5B there is shown one example of gaming system 200 in which the outcome has determined that the player is to be awarded a prize. The outcome is displayed by reels 216a, 216b, and 216c and the prize is displayed by animated FIG. 205 and animated element 208 that identifies a prize in display window 210 that identifies 32 credits. It shall be appreciated by those skilled in the art having the benefit of this disclosure that control system 30 controls the operation of animated element 208 that identifies the prize.

Referring to FIG. 5C, there is shown another example of gaming system 200 that also provides the player with a “multiplier” prize illustrated by display component 220. The multiplier prize may be based on a multiple of credits played or may be a separate game that is subject to a bonus activating event. In this embodiment, the bonus activating event and the bonus prize are determined by game device 202. Alternatively, the bonus prize may be determined by animated display device 204 as described previously.

The method of operation for animated gaming system 200 is similar to the method described in FIG. 2A described above. Preferably, the pay table will be associated with gaming device 202 and the movements of animated FIG. 205 are based on communications from gaming device 202. Alternatively, a pay table may be resident in control system 30 of animated display device 204.

Additionally, as shown in FIG. 5A, gaming system 200 may include a dispensing module 222 that may dispense a fortune or some other type of information.

### Gaming Systems Having Multiple Animated Elements

The animated figures may include more than one animated element and/or multiple movement modes. For example, the animated figure itself may move back and forth on a display, or may rock from side to side. In addition, animated elements may be included that are separate from the animated figure. The use of additional animated elements may serve to further increase player excitement, allow game developers more creative freedom in developing games for players, and allow game developers to develop new methods for awarding prizes.

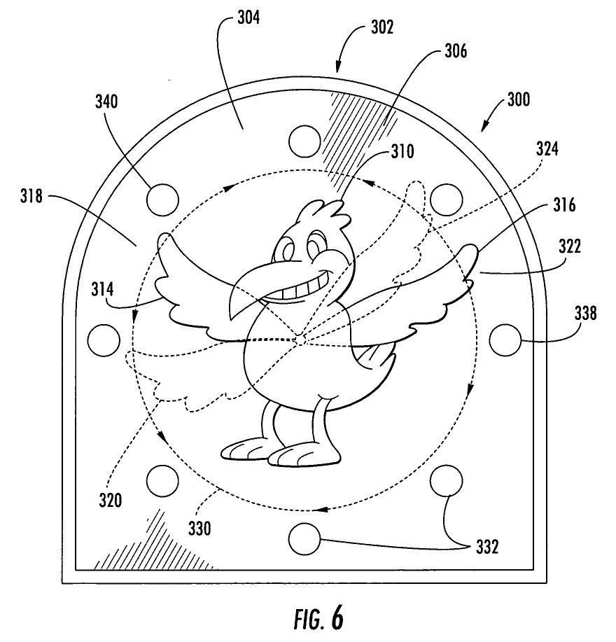

FIG. 6 depicts one example of an embodiment of Applicants' invention having multiple animated elements, and is generally indicated as 300. Embodiment 300 preferably includes a housing 302. Housing 302 may be made of plurality of walls defining an enclosure. Housing 302 may define a structure of embodiment 300 and may encase at least some of the components of embodiment 300. In a preferred embodiment, housing 302 is designed according to a theme of the gaming apparatus. Housing 302 includes a display area 304.

Animated FIG. 310 is disposed on or within housing 302. Although FIG. 6 depicts animated FIG. 310 as a bird, those of skill in the art will recognize that a variety of different representations could be used for animated FIG. 310. Animated FIG. 310 preferably has two animated elements (which may be, but are not necessarily indicators) 314 and 316, depicted as wings in FIG. 6. Animated elements 314 and 316 are preferably independently animated by a controller (not shown). The controller may be similar to previously described controllers, such as motor controller 44 and/or processor 32. The controller is preferably capable of independently controlling at least two animated elements.

Animated elements 314 and 316 are preferably moveable between a plurality of positions. For example, animated element 314 may be moved between position 318 and position 320. Animated element 316 may be moved between position 322 and 324. Animated elements 314 and 316 are preferably rotatable about an axis of rotation perpendicular to the plane formed by the front of housing 302. It is preferable that both animated elements 314 and 316 be rotatable both clockwise and counterclockwise. As elements 314 and 316 are rotated, they will trace a circle, generally indicated by 330.

Preferably, a variety of prize displays 332, as best shown in FIG. 6, may be disposed about circle 330. Prize displays 332 may appear as objects painted on a glass front of housing 302, may be lighted indicators, LED meters, video displays, objects, or any other means of representation.

Preferably, prize displays 332 represent things associated with the gaming device. For example, prize displays 332 may represent bonus values, bonus multipliers, prizes, a good or a service, or other gaming indicia.

In one embodiment, prize displays 332 all represent the same thing. For example, prize displays 332 could represent bonus amounts that may be awarded to a player. A random number generator associated with a controller could determine a prize to be awarded a player. The controller could direct animated elements 314 and 316 to point to the prize displays 332 that appropriately reflect the prize awarded the player. Similarly, prize displays 332 could represent bonus multiplier amounts. In either case, the award or multiplier the player receives may also be the sum of prize displays 332 indicated by animated elements 314 and 316.

In an alternative embodiment, prize displays 332 represent different things. For example, a first prize display 340 could represent a bonus award and a second prize display 338 could represent a bonus multiplier. The player could be awarded a prize equal to the product of the bonus amount indicated by first prize display 340 and the multiplier indicated by second prize display 338.

Other displays may be used with animated FIG. 310. For example, rather than having one ring of prize displays 332, two rings could be used, similar to the display of FIGS. 5B and 5C. As in FIGS. 5B and 5C, one ring of prize displays could be located at a larger radial distance from a point on display 304 than the other ring of prize displays. Each animated element could be configured to indicate prize displays on a particular ring. Those of skill in the art will recognize that additional variations on display 302 could be developed and fall within the scope of the present invention.

Although the present invention is not limited to any particular type of actuator, one suitable actuator for moving animated elements 314 and 316 is shown in FIG. 7. A similar mechanism is disclosed in Applicants' copending U.S. application Ser. No. 10/245,625, the disclosure of which is expressly incorporated by reference. Animation mechanism 400 may be provided for selectively positioning first animation element 314 and second animation element 316 of animated FIG. 306.

In a presently preferred embodiment, actuating mechanism 400 may have a first stepper motor 402 and a second stepper motor 404. First stepper motor 402 may have a tube 406 that attaches to second animated element 316. Tube 406 preferably has a hollow center and is positioned within a central bore 403 of first stepper motor 402.

Second stepper motor 404 may have a shaft 410, which passes through first stepper motor 402 in tube 406 and attaches to first animated element 314. Shaft 410 preferably protrudes more from first stepper motor 402 than tube 406, thereby providing space between second animated element 316 and first animated element 314. Animated elements 314 and 316 may be moved clockwise or counterclockwise and may operate independently of each other.

Animation mechanism 400 may further have at least one position sensor. Tube 406 may be attached to first position sensor 408 in order to track second animated element 316. A second position sensor 412 may be attached to shaft 410 in order to track first animated element 314. First position sensor 408 and second position sensor 412 may have sensors 414 and 416 that detect rotation and transmit signals that can be used to determine the angular position of animated elements 314 and 316. A controller may be in communication with actuating mechanism 400 to selectively position indicators 314 and 316 around display 304. Of course, other animation mechanisms, now known and later developed, may be substituted and still fall within the scope of the present invention.

Animated FIG. 310 can be mounted as desired by a game developer. For example, animated FIG. 310 could be disposed within the housing, such that animated FIG. 310 is completely recessed within housing 302. A layer 306 of glass, acrylic, plastic, or other suitable, preferably transparent, material, may be placed in front of animated FIG. 310 in order to protect animated FIG. 310 and prevent tampering.

Animated FIG. 310 could be mounted outside of display covering 306. For example, animated FIG. 310 could be a cut-out figure mounted to the external surface of display covering 306. Animated FIG. 310 could be secured to the glass by an adhesive material or could be attached to the interior of housing 302. For example, animated FIG. 310 could be mounted to one or more rods (not shown) or shafts (not shown) extending from the interior of the housing to the exterior of the housing. Animated FIG. 310 could be secured to the rods or shafts by fastening means such as screws, pins, and other fasteners known in the art.

In a presently preferred embodiment, animated FIG. 310 is silk screened, or otherwise applied, to display covering 306. The risk of tampering with the gaming device is reduced if animated elements 314 and 316 are located behind display covering 306.

In an alternative embodiment, animated FIG. 310 could be mounted such that animated FIG. 310 is both behind and in front of display covering 306. Display covering 306 could include an opening configured to allow animated FIG. 310 to pass through. Animated FIG. 310 could be secured through previously discussed methods, including rods and shafts.

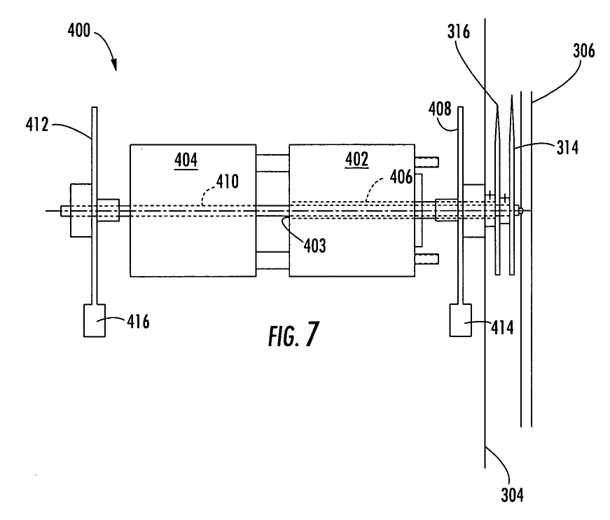

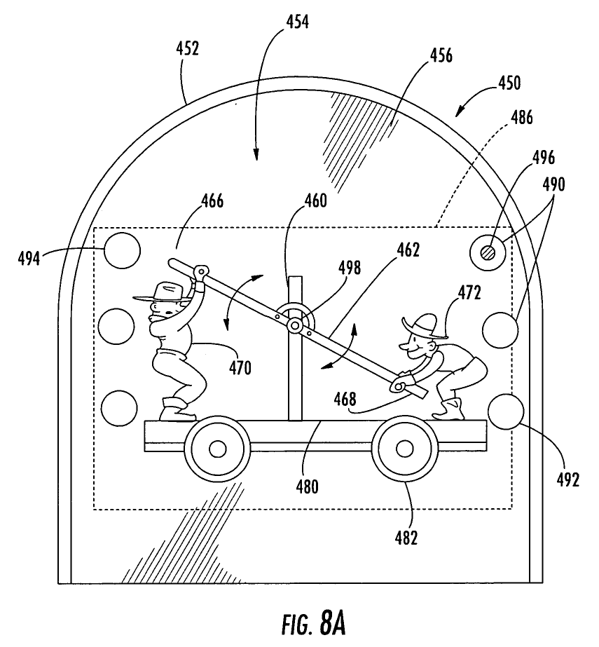

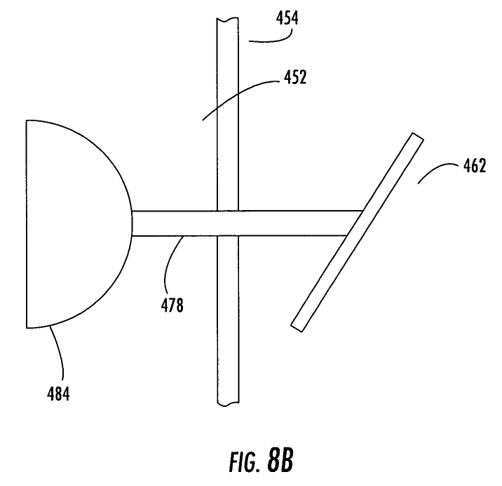

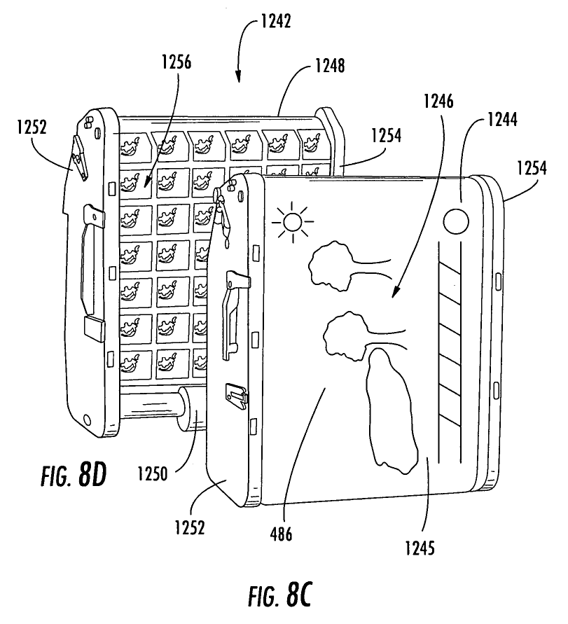

FIG. 8A depicts an additional alternative embodiment of the present invention, generally indicated as 450. Embodiment 450 includes a housing 452 that is similar to those previously described. Housing 452 includes a display 454. Display 454 includes animated FIG. 460. Animated FIG. 460 is depicted as a manually operated railroad cart. Those of skill in the art will recognize that other animated figures or representations could be used.

Animated FIG. 460 includes first and second animated elements 470 and 472 and a central rotatable element 462. In FIG. 8A, central rotatable element 462 is the lever of the railroad car. Lever 462 has first and second ends 466 and 468. Lever 462 is rotatable about pivot point 498.

First and second animated elements 470 and 472 are moveable between at least a first and second position. First animated element 470 is depicted in a first position where first animated FIG. 470 appears to be in a standing position with the end 466 of the lever 462 in a comparatively elevated position. Second animated element 472 is depicted in a second position where the second animated element 472 appears in a bended position with the end 468 of the lever 462 in a comparatively lowered position. Animated elements 470 and 472 may be coupled to lever 462. In one embodiment, animated elements 470 and 472 are preferably constructed from an elastic material and passively move between the first and second positions according to the movement of lever 462.

Animated elements 470 and 472 are disposed on platform 480 of the railroad car. Platform 480 is shown with two mounted wheels 482. Platform 480 and wheels 482 are preferably three-dimensional. Wheels 482 are preferably moveable.

Animated FIG. 460 can be actuated by any number of mechanisms now known or later developed. By way of example only, and with reference to FIG. 8B, lever 462 may be mounted to a shaft 478 extending from the interior of housing 452. Shaft 478 may be coupled to stepper motor 484. Stepper motor 484 may be configured to selectively move lever 462 between a number of positions as directed by a controller (not shown).

Alternatively, animated FIG. 460 may be actuated by actuation of first and/or second animated elements 470 and 472. Animated elements 470 and 472 may be coupled to a shaft (not shown) extending from the interior of housing 452. The shaft can be attached to a second shaft (not shown) disposed in the interior of housing 452. The second shaft is preferably in communication with a solenoid (not shown), or other movement means. When the solenoid is activated, the second shaft will be biased in an upward direction, in turn moving the first shaft upwards. Deactivation of the solenoid results in the first animated element 470 resuming its initial position. Because first animated element 470 is coupled to lever 462, and lever 462 is coupled to second animated element 472, actuation of first animated element 470 will also actuate lever 462 and second animated element 472. Animated elements 470 and 472 may be made of a flexible material that allows animated elements 470, 472 to bend and extend as they appear to move lever 462.

Of course, combinations, variations, and alternative actuation devices can be utilized without departing from the scope of the present invention. For example, animated elements 470 and 472 could each be operated by separate solenoid mechanisms, each mechanism being controlled by the controller.

The present embodiment of the invention allows for many game play options. Ends 466 and 468 of lever 462 preferably point to prize displays 490. For example, FIG. 8A shows lever end 466 indicating prize display 494 and lever end 468 indicating prize display 492.

Prize displays 490 preferably display indicia related to the game being played on the gaming device. Prize displays 490 may show monetary prize amounts, bonus multipliers, goods, services, prizes, among other things. Either or both sets of prize displays 490 can be used. Prize displays 490 can be of the same or different types. As an example, the prize displays indicated by ends 466 and 468 can both be bonus amounts. Either one or both ends 466 and 468 can indicate bonus amounts. If both ends 466 and 468 are to indicate bonus amounts, the bonus may be the sum (or any mathematical combination) of the indicia appearing on the prize displays indicated by ends 466 and 468.

Alternatively, indicia appearing on prize displays 490 can be of different types. For example, lever end 466 may indicate bonus award amounts. Pump end 468 may indicate multiplier amounts. The prize awarded to the player may be the product of the bonus amount and the multiplier. Lever arm 462 may be configured to have one active end that is used to indicate a prize. The end that is active would indicate the prize while the end that is inactive would not indicate a prize. Of course, both ends could indicate prizes. Lever arm 462 may be configured to indicate which ends are actively indicating prize displays. One such configuration would include lights (not shown), such as an LED, on ends 466 and 468 and to illuminate the lights when a particular lever end 466, 468 is active.

Indicia 496 displayed on prize displays 490 can be made to increase or decrease. One way this may be implemented is to have indicia 496 increase the longer animated elements 470 and 472 appear to move. For example, when indicia 496 are bonus amounts, the bonus amounts could increase the longer animated elements 470 and 472 appear to move. Of course, the particular indicia 496 displayed on prize displays 490 can be fixed or can be completely random.

The visual appearance of embodiment 450 can further be enhanced by including a changeable background 486 (generally represented by dashed lines) on at least part of the area of display 454. The use of changeable background 486 can increase the game options available to game developers, the variety of awards available to players, and the enjoyment and satisfaction experienced by game players.

Changeable background 486 is preferably an electronic display such as an LED display, LCD display, CRT tube, or plasma screen device, including displays typically used for television and computer screens. However, changeable background 486 is not limited to these types of displays and could include many other types of displays. As an example, it may be desirable to create a more old-fashioned looking display in order to go along with the hand operated railroad car depicted in FIG. 8A. Accordingly, changeable background 486 could be painted, drawn, or otherwise imprinted on a material such as paper, canvas, or plastics.

Referring now to FIGS. 8C and 8D, changeable background 486 may comprise a flat piece of material or band 1245 wrapped around a plurality of rollers 1248 and 1250. Rollers 1248 and 1250 rotate band 1245. Rollers 1248 and 1250 are preferably rotatably connected to chassis 1252 and 1254 and are preferably connected to an actuator (not shown). Band 1245 may have suitable background graphics 1246 on it that are part of changeable background 486.

Band 1245 may also have prize displays 1244 thereon. Prize displays 1244 may be affixed to band 1245 by various methods known in the art. Prize displays 1244 may be imprinted on band 1245 at different configurations depending on the desired appearance of prize displays 1244. In the embodiment shown in FIG. 8A, changeable background 486 may move from left to right relative to display 454 or vice-versa.

Thus, prize displays 1244 are preferably displayed in appropriate places to correspond to any background graphics 1246 on changeable background 486. A controller, such as controller 44 or processor 32 (FIG. 1B), preferably coordinates the movement of lever 462 (FIG. 8) with the movement of changeable background 486 to appropriately indicate prize displays 1244.

Preferably, light matrix 1256 is positioned behind band 1245 to back-light prize displays 1244 and background graphics on changeable background 486. Light matrix 1256 may comprise light emitting diodes (LEDs), fluorescent lights, incandescent lights, or other devices that may make band 1245 more attractive. A suitable display device 1242 may be obtained from Starpoint Electronics Ltd., of Chessington, UK.

Changeable background 486 can be incorporated into game play in a variety of ways. At a relatively simple level, changeable background 486 may be used to aid the illusion that animated FIG. 460 (FIG. 8) is in motion. At a more complex level, the movement of animated FIG. 460 can be correlated to the background being displayed on changeable background 486. For example, animated elements 470 and 472 (FIG. 8) might appear to be moving their cart up a hill and, therefore, the speed at which they move may be reduced. If animated FIG. 460 appeared to be going down a hill, or perhaps appeared to be chased by an object (such as a bear), elements 470 and 472 could be made to move faster.

At a slightly higher level of complexity, changeable display 486 and/or the animation speed of FIG. 460 may be correlated to prize displays 496 (FIG. 8). In the case of the railroad cart ascending a hill, the slower speed might correlate to a slower accumulation of a bonus. A background where the railroad cart appears to crash might result in the loss of a bonus. Other events might reduce the prize to be awarded a player. It should be apparent that a great deal of variation can be carried out in this aspect of the present invention.

At a yet higher level of complexity, changeable background 486 can be made to give the player the appearance of being able to control, or at least influence, the outcome of the game. For games of chance, regulations sometimes dictate that players have no control, and the outcome of a game is preferably determined solely by a random number generator.

In this aspect of the invention, the player is preferably allowed to indicate a preference via an input device, such as buttons, a mouse, a keyboard, or a touch screen. An example of this embodiment will be described using the railroad motif of FIG. 8A. However, it will be appreciated that this embodiment is generally applicable and is not limited to one particular motif, style, or type of animated FIG. 460 or changeable background 486.

Changeable background 486 can be displayed such that it appears that railroad cart 460 is traveling down a train track. At various points, a player may be prompted to provide input via the input device and choose a course of action for the cart 460. This may, for example, be a fork in the track with the game player able to choose a path the railroad cart 460 will follow. The changeable background 486 will be displayed based on the player's choice. Of course, many other situations could be devised that would facilitate player input and are considered within the scope of the present invention. By providing an illusion of player choice, player interest in playing the gaming device can be increased, while at the same time complying with regulatory requirements.

Additional animated elements can be included on animated FIG. 460. For example, wheels 482 attached to platform 480 are preferably moveable. Wheels 482 may be actuated by any number of actuating devices, including servo and stepper motors (not shown). Wheels 482 may be controlled separately or jointly. The rotational speed of wheels 482 is preferably correlated to the pumping speed of animated elements 470 and 472. When used in conjunction with changeable background 486, the rotational speed of wheels 482 is also correlated to the background being displayed. For example, if changeable background 486 makes it appear that the railroad cart 460 was going down a hill, it may be desirable to have wheels 482 turning at a high rate of speed even if animated elements 470 and 472 were not pumping or were pumping at lower rate. Platform 480 could be rotatable in order to aid the illusion that railroad cart 460 is ascending or descending.

Another embodiment of the invention is shown in FIG. 9A and is generally indicated as 500. Embodiment 500 includes a housing 502, a display area 503, and preferably including a display covering 504 made from any of a variety of transparent materials including glass, plastic, acrylic, and Plexiglas.

Embodiment 500 also includes an animated figure, generally indicated as 506. As shown in FIG. 9A, animated FIG. 506 has an animated element 526 which defines an elephant trunk. Trunk 526 includes an outer portion 510 disposed outside housing 502 and an inner portion 524 disposed within housing 502 under display covering 504. Animated FIG. 506 is preferably constructed such that it appears that outer portion 510 and inner portion 524 are of unitary construction and that outer portion 510 enters housing 502 through an opening 522 in display covering 504.

Housing 502 preferably has a plurality of prize displays 530 for displaying indicia 534 relating to a game being played on the gaming device. Indicia 534 may be anything related to the gaming device. For example, indicia 534 might represent monetary prize amounts, bonus multiplier amounts, or other types of awards. Prize display 530 can display more than one type of indicia 534.

Inner portion 524 is preferably moveable and configured to indicate one or more indicators 530. In the elephant motif of FIG. 9A, the end of the elephant's trunk 526 may move to point to various prize displays. As shown, trunk 526 is pointing to prize display 532.

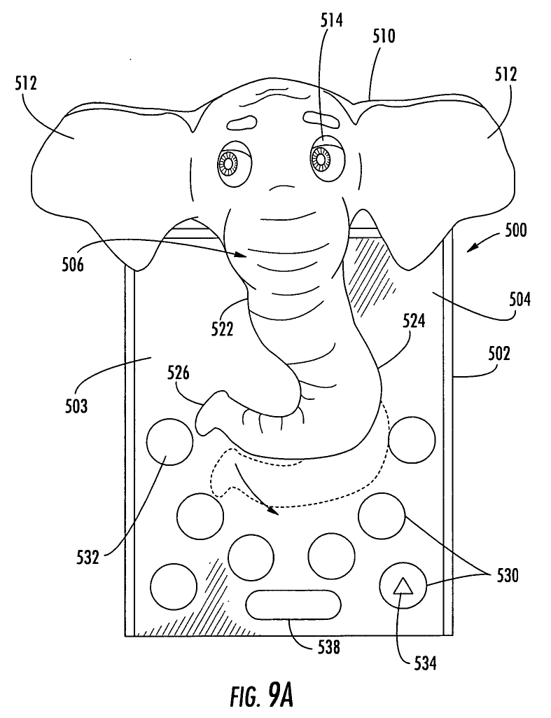

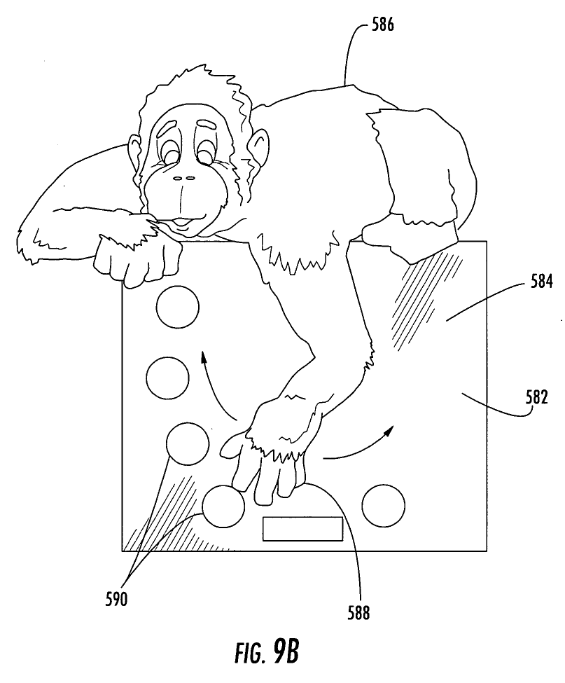

Inner portion 524 is preferably made of a flexible material such as vinyl or rubber. Inner portion 524 may be moved by any number of actuating mechanisms known to the art. By way of example only, inner portion 524 may be moved by means of an actuating mechanism 516, examples of which are shown in FIGS. 10A and 1B.

FIG. 10A again shows animated FIG. 506 as an elephant head 508 with an animated element, or trunk 526. As was previously described, trunk 526 may be moved to indicate a number of prize displays 530. Trunk 526 may be attached to actuating mechanism 516 through guide track 568. Guide track 568 may guide trunk 526 and maintain the end of trunk 526 in proximity to prize displays 530.

FIG. 10B provides more detail on actuating mechanism 516 of FIG. 10A. Trunk 526 of animated FIG. 506 may be moved by worm gear 564. A bracket 570 may be attached a biasing mechanism, or a slider mechanism, 574. Biasing mechanism 574 (which may be a spring) may be attached to a pin 566. Pin 566 may extend through guide track 568 and attach to trunk 526. Bracket 570 may have parallel rods 572 in order to hold and guide trunk 526 as bracket 570 travels along worm gear 564 (in order words, rods 572 keep trunk 526 from rotating when worm gear 564 is rotated). Bracket 570 may be threadably attached to worm gear 564. Bracket 570 may have a nut (not shown) for attaching bracket 570 to worm gear 564.

Worm gear 564 may be actuated by actuator 560. Actuator 560 may be a motor, including, without limitation, stepper motors, servo motors, gear motors, d.c. motors, and the like. Actuator 560 drives a belt 562 that in turn rotates worm gear 564.

As worm gear 564 rotates, bracket 570 will move linearly along worm gear 564. As bracket 570 moves, pin 566 will move along guide track 568. The portion of trunk 526 between bracket 570 and pin 566 may be constructed from a flexible material or the actuation system otherwise designed so that trunk 526 may move from the relatively compressed position at the ends of worm gear 564 to the relatively extended position when trunk 526 is in the middle portion of worm gear 564. In one embodiment, the trunk length is determined by the maximum distance between worm gear 564 and guide track 568. Trunk 526 may be made of a flexible material that will fold to one side when trunk 526 is at the ends of worm gear 564, similar to what is depicted in FIG. 9A.

Although guide track 568 is shown as an arc, guide track 568 could be linear, S-shaped, or other shapes, as desired by a game designer. Sensors (not shown) may be provided to allow a controller (not shown) to detect the position of bracket 570. It may be desirable to include additional actuation devices to actuate other areas of inner portion 524 (FIG. 9A). Additional actuation devices may create more realistic movements. For example, a second worm gear may be associated with inner portion 524 of the elephant's trunk 526.

In operation, the controller may cause worm gear 564 to move end of trunk 526 to indicate the prize display selected by the controller. As has previously been discussed, prize displays 530 (FIG. 9A) can represent bonus monetary amounts, bonus multipliers, other prizes, or any other indicia related to the underlying game. It is also possible for animated FIG. 506 (FIG. 9A) to indicate more than one prize display 530, and for prize displays 530 to indicate more than one type of indicia 534. For example, the controller could direct animated FIG. 506 to point to a plurality of indicia 534 (FIG. 9A) representing monetary prizes. The plurality of monetary prizes could be added together and awarded to the player. Similarly, the controller could direct animated FIG. 506 to first select an indicia 534 representing a monetary amount and then to select an indicia 534 representing a multiplier and award the player the product of the monetary amount and the multiplier. Of course, other variations are possible as desired by the game designer and are considered within the scope of the present invention.

Additional animated elements can be included with animated FIG. 506 in order to enhance the appearance of the gaming device. For example, other lifelike features can be added to animated FIG. 506. In the embodiment shown in FIG. 9A, additional features of the elephant can be animated. For example, eyes 514 can be made to shift from side to side. Ears 512 can be made to move back and forth. These additional animated features can be correlated to the underlying game and controlled by the controller.

In a presently preferred embodiment, display 503 includes an electronic display area 538. Display 538 is not limited to a particular display means and may be a LED display, an LCD screen, a CRT display, a plasma screen, or other display devices known to the art. Display 538 preferably displays messages and/or values related to the underlying game. For example, display 538 may indicate the total award to which a player is entitled, a bonus multiplier, or other values. Display 538 could also display messages, such as “You're a winner!” or “Sorry, better luck next time.” Display 538 can also display game instructions or display messages or graphics designed to attract players to the gaming device.

FIG. 9B illustrates a similar embodiment to that shown in FIG. 9A. In FIG. 9B, animated FIG. 586 is depicted as a monkey with animated element 588, which defines an arm. Arm 588 extends from outside display covering 584 to the inside of display covering 584. Arm 588 is moveable about the surface of display 582 and may be moved proximate to one of a plurality of prize displays 590. The actuation devices may be the same as those used for the embodiment illustrated in FIG. 9A, including actuator 516 illustrated in FIGS. 10A and 10B.

With reference now to FIG. 11, another embodiment, generally indicated as 600, is described. Embodiment 600 includes a housing 602 having a display area 604. In one embodiment, display area 604 is preferably covered by display covering 606, as already described.

FIG. 11 includes an animated FIG. 616. In FIG. 11, animated FIG. 616 is depicted as a boat 618 having animated elements 620 and 622, which define fishermen. Other representations could be used as desired and considered within the scope of the present invention.

First and second fisherman 620 and 622 further include first and second fishing poles 624 and 626. Each fishing pole 624 and 626 has a fishing line 630 and 634 having hooks 632 and 636. Display 604 preferably includes a plurality of prize displays 644. Prize displays 644 may comprise any previously described prize display. As with previous embodiments, prize displays 644 preferably display indicia 649 related to a game played on the gaming device.

At least one of the animated elements 620, 622 may indicate a prize to be awarded to a game player. Boat 618 may be configured to move, preferably to rock up and down, as if by waves or as if fishermen 620 and 622 have hooked a fish. Boat 618 can be moved by any number of actuating mechanisms now known or later developed. As a non-limiting example, boat 618 can be attached to a rod (not shown) attached to a motor (not shown), including, but not limited to, servo motors and stepper motors (not shown). The motor is preferably in communication with a controller (not shown) that directs the movement of boat 618.

As boat 618 rocks back and forth, fishing lines 630 and 634, and therefore hooks 632 and 636, will move up and down on display 604. As hooks 632 and 636 move up and down on display 604, they preferably will be proximate to various prize displays 644. The controller is preferably capable of directing the motor to move the boat such that a particular prize display 644 may be indicated by hooks 632 and 636 as required by the game.

As additional or alternate animated elements, fishing poles 624 and 626 can be moveable. Poles 624 and 626 can be moved by any known or later developed actuator. Fishing poles 624 and 626 may be connected to a servo motor or stepper motor by a rod (not shown). The motor is preferably in communication with a controller capable of moving poles 624 and 626 up and down as needed in order to indicate particular prize displays 644. Other actuators, such as worm gears and solenoids, could also be used to actuate poles 624 and 626.

Fishing lines 630 and 634 could also be animated elements of animated FIG. 618. Fishing lines 630 and 634 could be wound around a spool (not shown), or similar object, which may be mounted in an unobtrusive location, such as behind fisherman 620 and 622 and/or boat 618. The spools may be in communication with an actuator, including motors such as stepper motors and servo motors, which is preferably in communication with a controller. The controller preferably directs the spools to wind or unwind as necessary to increase or decrease the height of hooks 632 and 634 in order to bring hooks 632 and 634 proximate to desired prize displays 644.

It will be appreciated that any combination of animated elements could be used. The use of multiple animated elements may increase the complexity of the apparatus but also increases the options available to the game developer and may increase the realism of animated element 616.

Some possible methods of using the previously discussed animated elements will now be described, without limiting the use of the disclosed animated elements. A controller may direct boat 618 to rock back and forth to simulate the boat being rocked by waves. When it is desired to make it appear that fisherman 620 and 622 have caught a fish, the end of boat 618 nearest the fisherman 620 or 622 that has hooked the fish can be moved downward to simulate the pull of the fish on hook 632 or 636.

When fishing poles 624 and 626 are an animated element, the controller may direct poles 624 and 626 to move downward when it is desired to make it appear that fisherman 620 or 622 has hooked a fish. In addition, poles 624 and 626 can be moved upwards and then downwards, to make it appear that fishermen 620 and 622 are casting lines 630 and 634.

When lines 630 and 634 are an animated element, the controller can direct lines 630 and 634 downward to make it appear the fisherman 620 and 622 are trying to catch fish in deeper water. Similarly, the controller can direct lines 630 and 634 to move higher on display 604 when it is desired to make it appear that fisherman 620 and 622 are moving hooks 632 and 636 to shallower waters. Lines 630 and 634 can also be moved upwards when it is desired to make it appear than fisherman 620 and 622 have caught and are reeling in a fish.

Prize displays 644 can be designed to complement the motif of display 604 and animated FIG. 616. For example, in the fishing motif of FIG. 11, prize displays 644 could be various fishing related objects, such as fish, other sea creatures, tires, sunken treasure, or other objects. Prize displays 644 can be fixed or changeable. For example, prize displays 644 could be fixed images or representations of fish. Prize display 644 could be changeable representations, and could be displayed by LEDs, LCD displays, CRT tubes, plasma screens, or other changeable displays known to the art or later developed.

When prize displays 644 are changeable, prize displays 644 can be animated to further add to the realism of display 604. For example, prize display 644 could be made to appear to swim. It could be made to appear that a first prize display fish having a value has eaten a second prize display fish having a value, with the value of the first prize display fish being increased after appearing to consume the second fish.

Whether changeable or fixed, it will be realized that the representation of prize displays 644 can be coordinated to the prize displayed by the prize displays. For example, when prize displays 644 represent monetary prizes, larger fish might represent larger monetary prizes. Similarly, a representation of a tire or a shark might indicate a losing outcome while a representation of a treasure chest or similar object might represent a larger jackpot or progressive prize.

Display 604 might include animated display area 608 (generally represented by dashed lines), similar to that in FIG. 9. Animated display area 608 can enhance the visual appearance of the gaming device and display 604. Display 608 could display an appropriate background, such as waves, islands, shore, other boats, or similar such representations consistent with the motif of the game and display 604.

Another embodiment, generally indicated as 650, is depicted in FIG. 12. As with previously described embodiments, embodiment 650 has a housing 652 with a display area 654 that is preferably at least partially covered by display covering 656. Display 654 includes animated FIG. 660.

Animated FIG. 660 is preferably moveable. As shown in FIG. 12, animated FIG. 660 may be moved up and down. Animated FIG. 660 may include an additional animated element, such as moveable arm 662. Animated FIG. 660 and moveable arm 662 may be actuated by any means now known or later developed.

Without limiting the present invention, one possible actuating mechanism 700 for animated FIG. 660 and moveable element 662 is depicted in FIG. 13. FIG. 13 shows a motor 702 in communication with worm gear 704. Motor 702 may be a variety of motors, including stepper motors and servo motors. Bracket 708 may be threadably mounted to worm gear 704 by nut 710. Rod 712 connects bracket 708 to animated FIG. 660. When an animated arm element is included, motor 714 may be included and attached to arm 662 by rod 716. In this way arm 662 can be made to move independently of the position of FIG. 660. Motor 714 may be a variety of motors, including servo motors and stepper motors. Rod 712 and/or rod 716 preferably extend from behind display 654 through slot 664.

Motor 714 is preferably attached to rod 716 or bracket 708 so that motor 714 will move with animated FIG. 660. Motor 702 and/or motor 714 may be in communication with a controller (not shown) that coordinates movement of animated FIG. 660 and arm 662 with the operation of a game on the gaming device.

As best shown in FIG. 12, animated FIG. 660 and/or arm 662 may be used to indicate a variety of prize displays 670, 686, and 680. The prize displays may be of a variety of types, including imprinted indicia, lights, LED displays, or displays such as LCD displays, CRT tubes, plasma displays, and other display devices known or later developed.

In one embodiment, prize displays 670 display indicia 676 related to a game being played on the gaming apparatus. For example, indicia 676 may indicate that a player is entitled to a monetary bonus, may display the amount of the monetary bonus, or the value of a bonus multiplier. Indicia 676 may indicate that the player is entitled to a free play and/or the amount of free play. Indicia 676 may represent an amount of money.

Prize displays 670, 686, 680 can also represent bonus games. For example, prize display 686 may be a slot-machine type display made of physical or virtual reels 692. Reels 692 may have a plurality of indicia 690. Winning combinations are preferably determined with reference to one or more pay lines 688. Animated FIG. 660 can be moved to indicate a particular pay line that is active or that will determine whether a player is to be awarded a prize.

Arm 662 may also be used to indicate a particular prize display 670, or a particular part of an indicator. For example, when prize display 686 is used as a slot machine representation, animated FIG. 660 may move proximate to prize display 686. Arm 662 may be used to indicate which pay line 688 is active. Alternatively, once animated FIG. 660 is proximate prize display 686, prize display 686 can be activated such that a game outcome is displayed on prize display 686. Arm 662 may then indicate which pay line determines whether a player is to be awarded a prize.

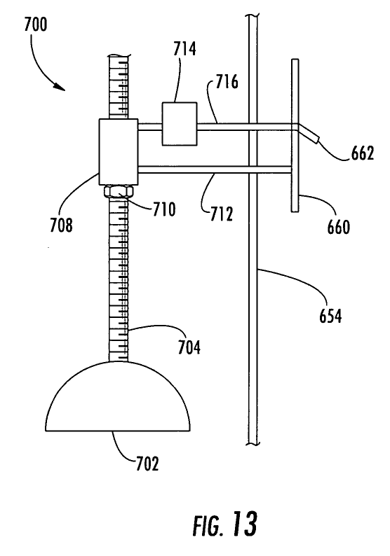

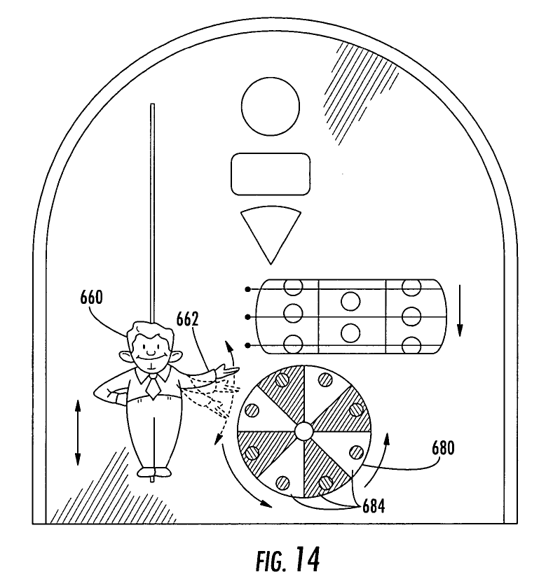

With reference now to FIGS. 12 and 14, it can be seen that prize display 680 may operate in a manner similar to prize display 686. Prize display 680 may be a physical or virtual representation of a wheel, preferably having a plurality of sections 684. Each section 684 preferably has at least one indicium 682 indicating a game outcome and/or prize to which a player may be awarded. As with prize display 686, animated FIG. 660 and/or arm 662 may be moved to indicate a particular section 684 that determines a game outcome.

It will be realized that various combinations of prize displays could be used. For example, a game could be designed such that a player is potentially entitled to one or more prizes displayed on prize displays 670, 680, and 686. For example, as animated FIG. 660 travels up or down slot 664, a player might be awarded a prize, or at least have a chance at being awarded a prize, at each level at which animated FIG. 660 stops.

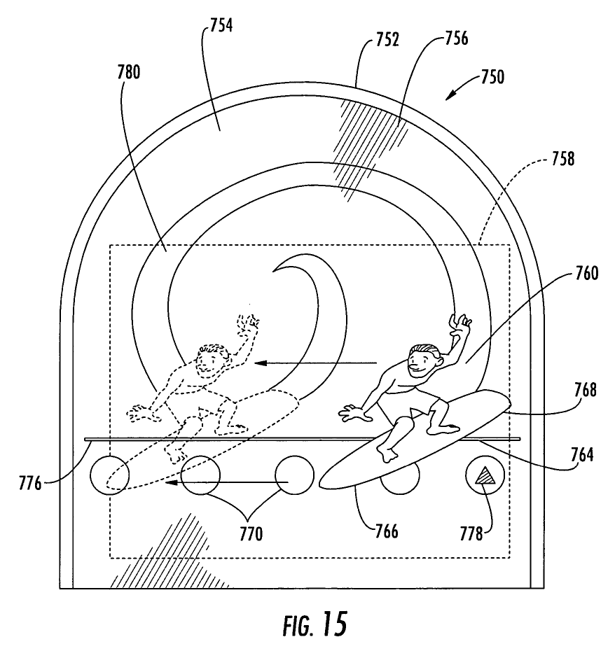

FIG. 15 depicts another embodiment of Applicants' invention, generally indicated as 750. Embodiment 750 preferably includes a housing 752, a display area 754, and may include display covering 756. Embodiment 750 also includes animated FIG. 760.

Animated FIG. 760 is moveable on display 754. Animated FIG. 760 may be moved by known or later developed actuating mechanisms, including a variation of the worm gear/stepper motor combination shown in FIG. 13. The actuating mechanism of FIG. 13 is preferably modified for animated FIG. 760 by having motor 714 rotate a rod 716 that is attached to animated FIG. 760, rather than rotating a separate moveable element of the animated figure. Of course, other actuating devices could be used.

The actuating device preferably may rotate animated FIG. 760 in a clockwise and counterclockwise manner so that either tip 766 or tail 768 of surfboard 764 is pointing towards the bottom of display 754. By moving animated FIG. 760 back and forth along slot 776, and/or rotating animated FIG. 760, indicators 770 can be indicated by tip 766 or tail 768 of surfboard 764. Indicators 770 can be any of the previously described prize displays, displaying any of the previously described game indicia. For example, indicia 778 could represent monetary prizes, bonus multipliers, or other prizes.

Display 754 may include a changeable background portion 758 (generally represented by dashed lines), as has been previously described, in order to enhance the visual appearance of display 754 and the gaming device. Display 754 may also include designs related to the motif of display 754, such as a depiction of a wave 780 for the surfing motif illustrated in FIG. 15.

FIG. 16 illustrates another embodiment of the present invention, generally indicated as 800. Embodiment 800 has a housing 802, a display area 804, and preferably has a display covering 806.

As shown in FIG. 16, embodiment 800 has an animated FIG. 814 that may be hidden by display element 810. As illustrated, animated FIG. 814 is a hand and display element 810 is a hat. Of course other animated FIGS. 814 and display elements 810 may be used. Display element 810 is shown as being a fixed object in FIG. 16, but could also be an animated or moveable object.

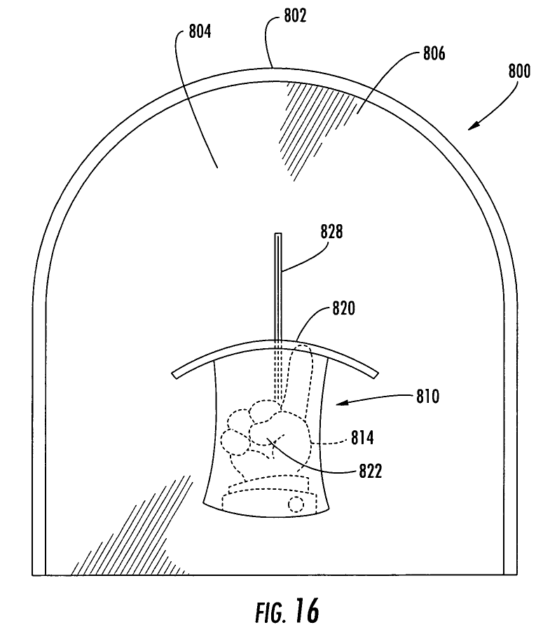

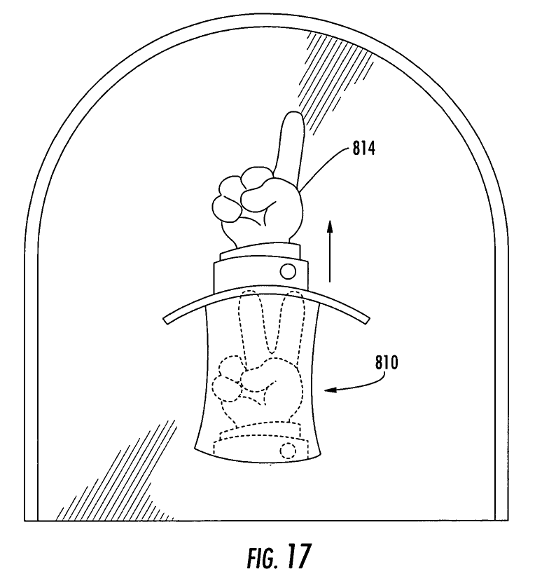

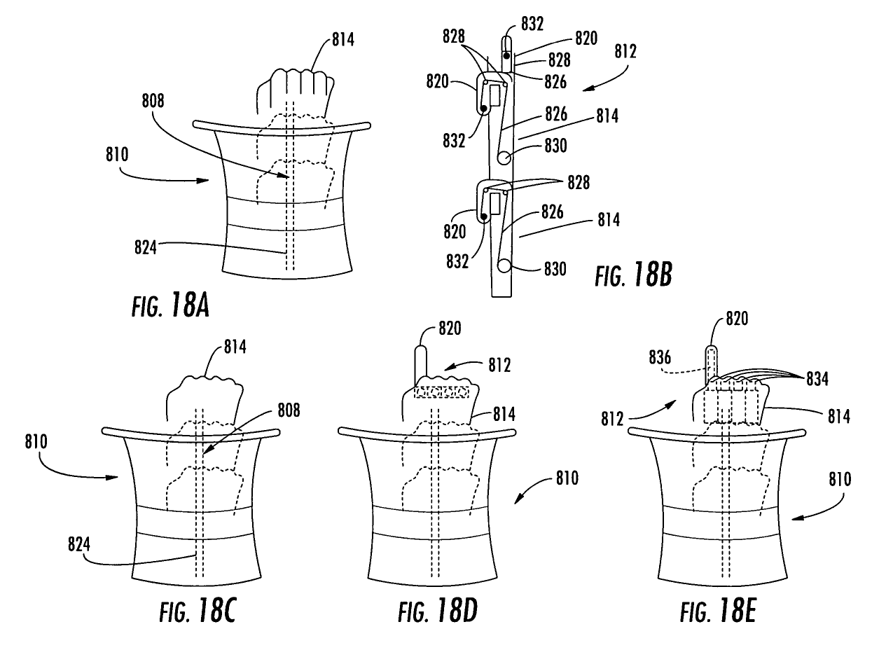

As best shown in FIGS. 18A-18C, hand 814 is preferably attached to an actuating device 808 for movement in an up or down manner. Actuating device 808 for hand 814 may be any known or later developed actuating device, but may include a worm gear (not shown) or a solenoid (not shown). The operation of suitable worm gears and solenoids has previously been described. As shown in FIGS. 18A and 18C, hand 814 may have a shaft 824 that is coupled to an actuator (not shown). Animated FIG. 814 may be attached to actuating device 808 through slot 828 (FIG. 16).

FIGS. 17 and 18C show animated FIG. 814 above display element 810. FIG. 18D shows hand 814 above display element 810 and with an animated element 820 defining a finger 820 extended.

As best shown in FIGS. 18A-18E, animated FIG. 814 preferably has a number of animated elements or fingers 820, which may include a thumb 822 (FIG. 16), that can flex and extend. Fingers 820 are preferably moveable between a first position in which they form part of a fist and a second position where the fingers are extended. An actuating device 812 is preferably in communication with animated elements 820.

Actuating device 812 may be any known or later developed actuating device, but could be a solenoid or worm gear, such as those already described. Animated element actuating device 812 is preferably connected to animated elements 820 so that the animated element actuating device 812 travels along with animated FIG. 814.

Thumb 822 (FIG. 16) of hand 814 is preferably made of a flexible material and may be biased away from hand 814. When animated element actuating device 812 extends a finger 820, thumb 822 will be pushed out of the way to allow finger 820 to pass. When actuating device 812 moves finger 820 in a downward position, thumb 822 will again be moved aside to allow finger 820 to pass and resume position as part of the fist.

If desired, additional devices can be included to aid in positioning fingers 820. For example, projections, guides, levers, and other devices can be included in the interior of display element 810 in order to guide, push, or otherwise position thumb 822 (FIG. 16) or fingers 820 into the appropriate positions. Positioning such devices behind display element 810 is beneficial because it may prevent players from seeing mechanical aspects of the gaming device. It is presently preferred to position finger 820 and thumb 822 while hand 814 is behind display element 810. In this embodiment, it is possible for animated element actuators 812 to not move with the animated figure actuator 808 and to engage and disengage fingers 820 when hand 814 is brought back behind display element 810.

Another possible animated element actuating mechanism 812 for fingers 820 is illustrated in FIG. 18B. The lower portion of FIG. 18B shows hand 814 with finger 820 in a retracted, or flexed, position. A cable 826 inside finger 820 may be connected to a motor 830. Cable 826 may pass over, and be connected to, a plurality of cable guides 828. Cable guides 828 may be attached to finger 820. As cable 826 is actuated, it may pull finger 820 into an extended position, as illustrated in the upper portion of FIG. 18B. Finger 820 may be returned to a retracted position by a biasing device (not shown), such as one or more springs. A weighted pivot pin 832 may be used to drag finger 820 back into a retracted position when tension is no longer provided by cable 826. Alternatively, motor 830 can be directed to reverse the direction of movement of cable 826, moving finger 820 back into a retracted position. A cable sheath (not shown) may be used for keeping cable 826 in an appropriate position and for exerting a curling force.

FIG. 18E shows a hand 814 where solenoids 834 are used to actuate fingers 820. For example, one finger 820 is shown in an extended position. The shafts 836 of solenoids 834 may be attached to the end of finger 820 in order to both push finger 820 into an extended position, and also to pull finger 820 into a retracted position.

Fingers 820 of hand 814 may indicate a variety of game related elements. For example, the number of fingers 820 extending from hand 814 could be correlated to a prize number to be awarded a player or could indicate the value of a bonus multiplier. When fingers 814 are correlated to a bonus multiplier, a fist could indicate that no bonus is awarded. When fingers 814 are extended, the bonus multiplier would equal the number of fingers 814 extended. Of course, many other uses of animated FIG. 814 and elements 820, 824 are well within the skill of the art worker and are considered within the scope of the present invention.

FIG. 19 illustrates another embodiment of Applicants' invention and is generally indicated as 850. Embodiment 850 includes a housing 852, a display area 854, and preferably includes a display covering 856.

Embodiment 850 also includes animated FIG. 860 having animated elements 862 and 870. As shown in FIG. 19, animated element 862 is an arm. Arm 862 is preferably attached to a motor (not shown) so that arm 862 may be moved in the up and down manner indicated in FIG. 19. The motor may be any known or later developed actuating device, but is preferably a servo motor or worm gear, more preferably a stepper motor.

Animated element 870 may be the scroll shown in FIG. 19. Scroll 870 preferably may be unrolled to expose more of the scroll surface 884. For example the bottom of the scroll preferably may move between a first position 874 and a second position 876. An actuating device (not shown) is preferably provided behind display 854 for moving scroll 870. The actuating device may extend through slot 872.

The animated element actuating device (not shown) may be any known or later developed actuator, but may be a solenoid or worm gear, as have been previously described. The animated element actuating device may be attached to an object, such as a rod or similar object located in the bottom rolled portion of scroll 870. As the actuator moves up and down slot 872, the rod will roll or unroll the bottom of scroll 870. Of course, other actuating mechanisms may be used.

Scroll surface 884 may contain writing, or other indicia 886, including previously described indicia related to various game elements. For example indicia 886 may be monetary bonus amounts or bonus multiplier values. Preferably, arm 862 is rotated to indicate desired indicia 886 on scroll surface 884. Indicia 886 may appear on scroll surface 884 in any order and are preferably arranged such that more desirable awards are not visible until scroll 870 is at least partially unrolled towards second scroll position 876.

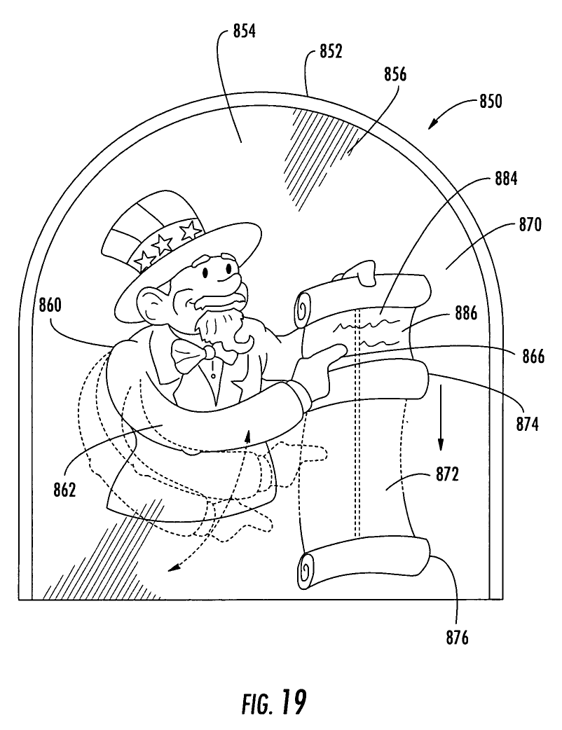

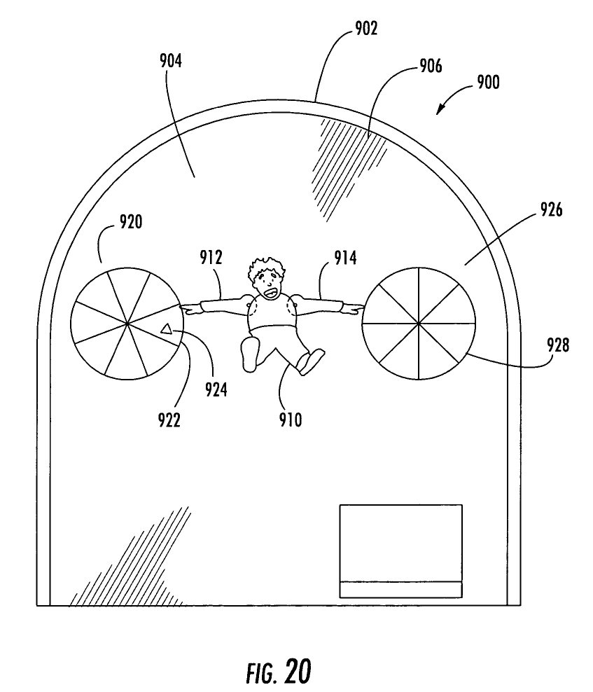

Another embodiment, indicated generally as 900, is illustrated in FIG. 20. Embodiment 900 has a housing 902, a display area 904, and preferably includes display covering 906. Embodiment 900 also includes animated FIG. 910. Animated FIG. 910 preferably has animated elements 912 and 914. As illustrated, animated elements 912 and 914 may be moveable arms of a human-like figure. Arms 912 and 914 are preferably pivotable.

Arms 912 and 914 may be moved by any known or later developed actuator, including worm gears, stepper motors, and servo motors, as have been previously described. The actuators are preferably stepper motors. The actuators are preferably in communication with a controller which may direct the actuator to move arms 912 and 914 to indicate a particular game outcome.

Arms 912 and 914 may point to various positions on prize displays 920 and 926. Prize displays 920 and 926 may be any previously discussed prize displays, but may have a number of indicatable positions, such as reel type displays (such as on slot machines) having multiple pay lines or wheels 922 and 928, as shown in FIG. 20.

Wheels 922 and 928 may be real or virtual and preferably are divided into a plurality of sections bearing game related indicia 924. For example, indicia 924 may represent monetary amounts or multiplier values. The type of indicia 924 appearing on wheels 922 and 928 can be the same or different. For example, both wheels 922 and 928 could have indicia 924 indicating monetary amounts, the player being awarded the sum of the amounts indicated on wheels 922 and 928. Alternatively, one wheel could indicate a monetary amount and the other wheel a multiplier amount, the player being awarded a prize equal to the product of the monetary amount and the multiplier. Of course, many other representations and permutations could be used and still be within the scope of the present invention.

FIG. 21 illustrates a variation of embodiment 900, indicated as 950. Embodiment 950 is preferably configured similarly to embodiment 900, including the operation of animated FIG. 910 having animated arms 912 and 914. However, embodiment 950 preferably includes a plurality of doors 960. Doors 960 may be mechanical or virtual doors.

Doors 960 preferably cover real or virtual prize displays 964. Prize displays 964 may display any previously discussed game indicia, including monetary award 970, progressive jackpot 972, bonus multiplier 974, and other prizes such as automobile 976. The indicia may be fixed or may appear randomly.

If prize indicia 970, 972, 974, 976 appear in random locations, a game player may be allowed to choose which door 960 to open. This choice provides the player an illusion of being able to choose or influence the game outcome, despite the game outcome preferably being randomly determined. The player's input could be through buttons (not shown), keyboard (not shown), mouse (not shown), touch screen (not shown), or other input devices known in the art or later developed.

Various actuating mechanisms (not shown) may be used for opening and closing doors 960. As a non limiting example, doors 960 may be mounted to a shaft (not shown) in communication with a motor (not shown). As the motor rotates the shaft, doors 960 may be opened and closed. Alternatively, the edge of the door 960 proximate the display area 904 may have an elongated portion extending above and/or below the door surface 962. A belt (not shown) may be looped around this elongated portion and the belt attached to the drive shaft of a motor. As the motor rotates the drive shaft, the belt will drive movement of doors 960 and may open and close doors 960.

Another embodiment, 1000, is illustrated in FIG. 22. Embodiment 1000 includes a housing 1002, a display area 1004, and preferably has a display covering 1006. Display area 1004 includes an animated FIG. 1010 having animated element 1014. Many types of animated FIGS. 1010 and animated elements 1014 could be employed, including the animated figure of a woman 1010 having an animated arm 1014, as shown in FIG. 22.

Animated arm 1014 may be configured as was animated arm 862 shown in FIG. 19 and previously described. Animated arm 1014 preferably indicates one of a plurality of prize displays 1022. Prize displays 1022 may be any of the previously described prize displays but preferably are doors 1024 covering indicia 1026. Doors 1024 and indicia 1026 may be configured in a similar manner to doors 960 and indicia 964 previously discussed in conjunction with FIG. 21. In a presently preferred embodiment, the player may control which door 1024 is selected by animated element 1014.

FIG. 23 illustrates another embodiment, 1100, of Applicants' invention. Embodiment 1100 has a housing 1102, a display area 1104, and preferably has a display covering 1106. Embodiment 1100 also has one or more animated FIGS. 1114.

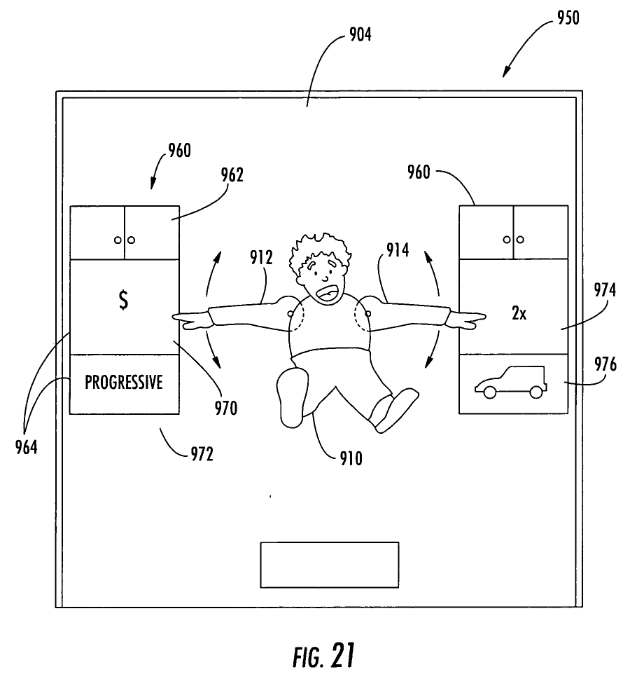

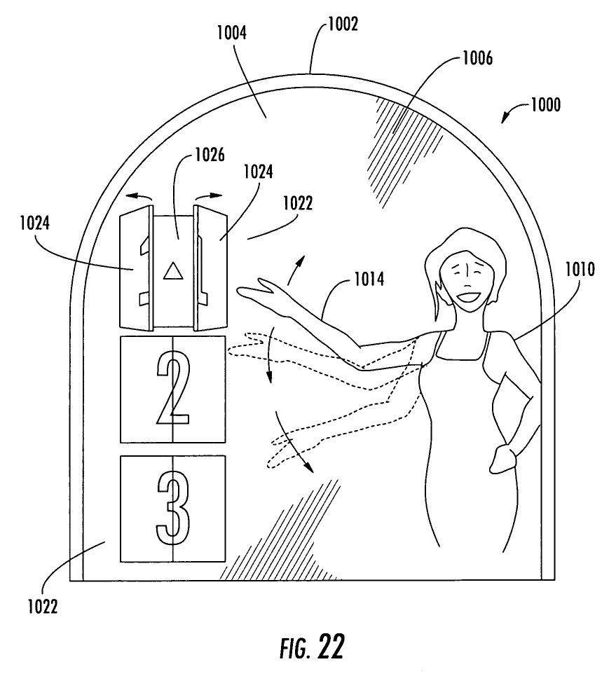

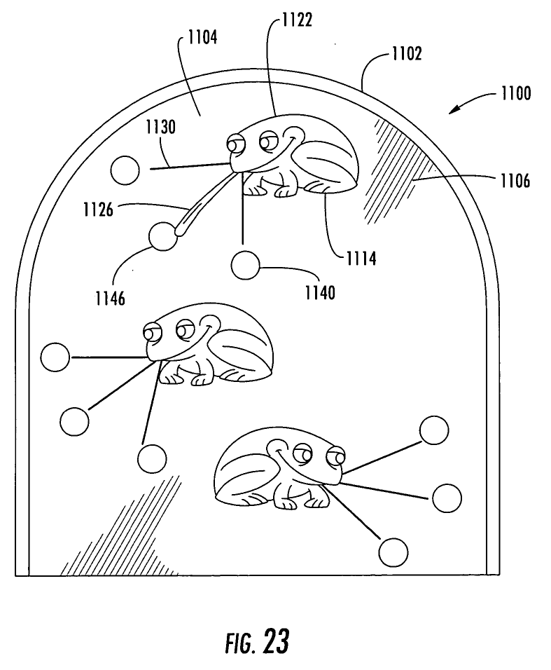

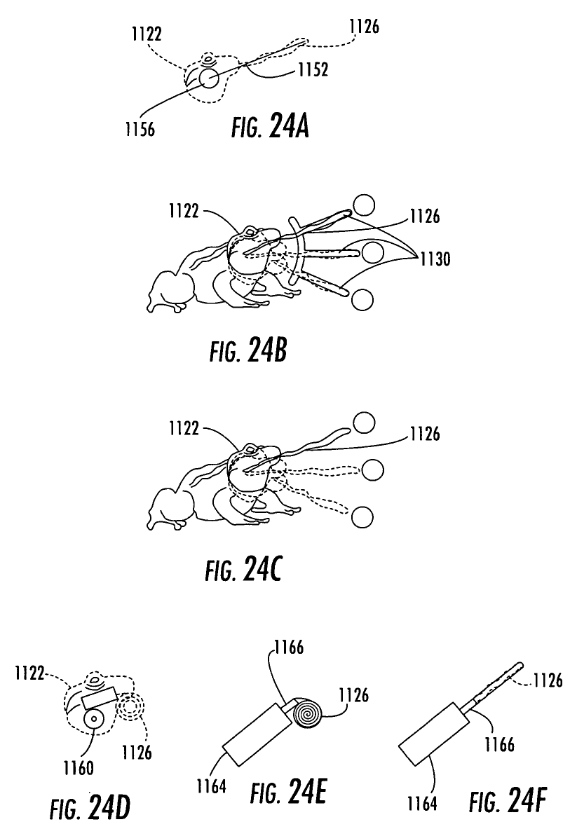

Animated FIG. 1114 may include one or more animated elements 1122 and 1126 defining a head and tongue respectively. In one embodiment, the head 1122 of FIG. 1114 is moveable. With reference to FIGS. 24A and 24D, head 1122 may be moved by an actuator 1156 or 1160. Actuators 1156 and 1160 may be any known or latter developed actuator, including, without limitation, stepper motors, dc motors, gear motors, and the like.

As further shown in FIG. 23, head 1122 may include a tongue 1126 extending from head 1122. In one embodiment, tongue 1126 is fixed in an extended position and will rotate up and down along with head 1122. Tongue 1126 may indicate one of a plurality of prize displays 1140. Prize displays 1140 may be any of the previously described prize displays, including those having indicia indicating monetary prizes and multiplier values.

In an alternate embodiment, tongue 1126 may be moveable independent of head 1122. Tongue 1126 preferably is initially within head 1122, or in a coiled configuration, extends to indicate a prize display 1140, and then retracts back within head 1122 (or re-coils). Tongue 1126 may be actuated by any known or later developed actuator. For example, tongue 1126 may be attached to a worm gear (not shown), as has previously been described The worm gear mechanism may be rotatable so that tongue 1126 may be moved along a selected track 1130 (also shown in FIG. 24B).

Another example of an actuator that could be used with the present invention is a pneumatic device (not shown). The pneumatic device may direct air into a hollow tongue, causing tongue 1126 to extend. Tongue 1126 could be biased, such as by a recoil spring, or by designing tongue 1126 to tend to coil on itself, such that tongue 1126 retracts into head 1122 (or coils upon itself) when the air pressure provided by the pneumatic device is insufficient to overcome the force of the spring. The rate of expansion and retraction of tongue 1126 could be varied by varying the air pressure directed into tongue 1126. Air pressure could be supplied by any suitable means, including a solenoid driven plunger (not shown).

Another non-limiting example of an actuator that could be used with the present invention is a solenoid 1164, as shown in FIGS. 24E and 24F. Solenoid 1164 may be directed to fire when directed by a controller (not shown). Solenoid 1164 may be connected to tongue 1126 and allow tongue 1126 to extend as shaft 1166 extends from solenoid 1164. As was previously described, tongue 1126 may be biased to retract when solenoid 1164 is at rest, or tongue 1126 could be made to tend to coil upon itself.

Whatever actuating mechanisms or moveable elements are chosen, prize displays 1140, as shown in FIG. 23, can be configured to respond to tongue 1126. For example, prize displays 1140 may be lighted. When unselected, the prize displays may be unilluminated. When it appears that tongue 1126 has selected a prize display 1140, such as prize display 1146 in FIG. 23, prize display 1140 may be illuminated.

### CONCLUSION

It can now be seen that the present invention solves many of the problems associated with the prior art. The present invention provides an animated gaming device and animated display device that may be used as a primary game or a bonus game or in combination with a primary game. The present invention provides an animated gaming device that includes an animated figure having an animated element.

Although the description above contains many specifications, these should not be construed as limiting the scope of the invention but as merely providing illustrations of some of the presently preferred embodiments of this invention. The specification, for instance, makes reference to bonus prizes. However, the present invention is not intended to be limited to bonus prizes. Rather it is intended that the present invention can be used independently as a stand-alone game. Thus, the scope of the invention should be determined by the appended claims and their legal equivalents rather than by the examples given.

What is claimed is:

1. An animated gaming system comprising:
a. at least one housing;
b. at least one display area located on the housing;
c. a plurality of prize displays displaying game related indicia disposed on the display area;
d. at least one animated figure coupled to the housing, the animated figure comprising:
i. a first animated element, the first animated element being at least part of, or operatively coupled to, the animated figure, wherein the first animated element is moveable between at least two positions, wherein in at least one position, the first animated element indicates at least one of the plurality of prize displays;
ii. a second animated element, which is at least part of or operatively coupled to the animated figure, wherein the second animated element is movable between at least two positions.

2. The animated game system of claim 1 wherein the animated figure comprises a representation of all or part of an animal, a bird, a human, a human-like figure, a boat, an automobile, or a train car.

3. The animated game system of claim 1 wherein the game related indicia displayed by the prize display indicated by the first animated element comprises a monetary award.

4. The animated game system of claim 1 wherein the second animated element indicates at least one of the plurality of prize displays and the game related indicia displayed by the prize display indicated by the second animated element comprises a multiplier.

5. The animated game system of claim 1 wherein in at least one position the second animated element indicates a prize display.

6. The animated game system of claim 5 wherein the prize display indicated by the second animated element comprises game related indicia.

7. The animated game system of claim 6 wherein the prize display indicated by the first animated element indicates different game related indicia than the prize display indicated by the second animated element.

8. The animated game system of claim 7 wherein the indicia on the prize display indicated by the first animated element comprises a monetary prize and the indicia on the prize display indicated by the second animated element comprises a multiplier.

9. The animated game system of claim 1 further comprising:
a. a first actuator located in the housing and coupled to the first animated element; and
b. a controller located in the housing determining a game outcome, and in communication with the first actuator, wherein the first actuator moves the first animated element in response to a signal sent by the controller.

10. The animated game system of claim 9 wherein the first actuator comprises a stepper motor.

11. The animated game system of claim 9 wherein the first animated element is in communication with the second animated element, whereby actuation of the first animated element by the first actuator may actuate the second animated element.

12. The animated game system of claim 9 further comprising a second actuator located in the housing and in communication with the second animated element, the second actuator in communication with the controller, wherein the second actuator moves the second animated element in response to a signal sent by the controller.

13. The animated game system of claim 12 wherein the first and second animated elements may be moved independently of each other by the first and second actuators in response to signals sent by the controller.

14. The animated game system of claim 1 wherein the animated figure represents a single object.

15. The animated game system of claim 1 wherein the animated figure comprises a plurality of objects.

16. The animated game system of claim 1 wherein the second animated element comprises the animated figure.

17. The animated game system of claim 1 wherein at least one of the prize displays comprises a plurality of rotatable sections, each section comprising at least one indicia.

18. The animated game system of claim 17 wherein the first animated element indicates a pay line comprising indicia on one or more rotatable sections.

19. The animated game system of claim 1 wherein the first animated element may be moved at various movement rates, wherein at least a portion of the plurality of prize displays comprise game related indicia having a value, whereby the value of the game related indicia is correlated to the movement rate of the first animated element.

20. The animated game system of claim 1 wherein the first animated element is animated for a time period having a duration, wherein at least a portion of the plurality of prize displays comprise game related indicia having a value, whereby the value of the game related indicia is correlated to the duration of the time period.

21. The animated game system of claim 1 further comprising a player input device in communication with the controller, the player input device allowing a player to provide player input, the first animated element being moved proximate a prize display according to the player input.

22. The animated game system of claim 21 wherein indicia is displayed on the prize display selected by the player after the player has entered the player input.

23. A gaming device comprising:
a. at least one housing containing game components;
b. a display area on the housing displaying a game to a player, the display area comprising:
i. a plurality of prize displays located on the display area and comprising game related indicia;
ii. an animated figure located on the display area and comprising at least one animated element, the animated element being moveable between at least two positions, wherein the animated element is proximate at least one prize display in at least one position; and
iii. a changeable display portion that displays changing images to a player

24. The gaming device of claim 23 wherein the game related indicia displayed on the prize displays is correlated to the images displayed on the changeable display portion.

25. The gaming device of claim 23 wherein the changing images are correlated to the animated figure.

26. The gaming device of claim 25 wherein at least a portion of the prize displays comprise images related to the animated figure or images displayed on the changeable display portion and the indicia appearing on those prize displays have a value, wherein the value of the game related indicia is correlated to the at least one prize display image.

27. The gaming device of claim 23 wherein the movement of the animated figure is correlated to the images displayed on the changeable display portion.

28. The gaming device of claim 23 wherein the prize displays appear on the changeable display portion.

29. The gaming device of claim 23 wherein the animated figure comprises a representation of all or part of an animal, a bird, a human, a human-like figure, a boat, an automobile, or a train car.

30. A gaming device comprising:
a. a housing for holding game components;
b. a game controller located in the housing, the game controller configured to present a game to a player and determine a game outcome;
c. a display area located in the housing; and
d. an animated figure disposed on the display area, the animated figure having a plurality of animated elements, the plurality of animated elements being moveable between at least a first and a second position, wherein the game outcome determines the position of at least a portion of the plurality of animated elements.

31. The gaming device of claim 30 wherein the position of the animated elements represents the value of a bonus multiplier.

32. The gaming device of claim 30 wherein the animated figure is moveable between at least a first and a second position.

33. The gaming device of claim 32 further comprising a display element located on the display area, wherein the animated figure can be moved behind the display element, thereby limiting the player's view of the animated figure.

34. The gaming device of claim 30 wherein the animated figure comprises a representation of all or part of an animal, a bird, a human, a human-like figure, a boat, an automobile, or a train car.

35. A gaming device comprising:
a. a housing for holding gaming components;
b. a game controller disposed within the housing, presenting a game to a player, and controlling the operation of various game components;
c. a display area located in the housing and viewable by a game player;
d. a display covering disposed over at least a portion of the display area, wherein the display area can be viewed from outside the housing through the display covering;
e. an animated figure located on the display area, wherein the display covering defines an aperture, wherein a portion of the animated figure extends from an interior of the housing, through the aperture in the display covering, and outside the display covering;
f. an animated element associated with the animated figure, located behind the display covering, and moveable between at least a first and a second position, wherein in at least one position, the animated element is proximate a prize display, denoting that the prize display has been selected; and
g. a first actuator located within the housing and in communication with the animated element and the game controller, wherein the first actuator moves at least a portion of the animated element in response to a signal transmitted from the game controller.

36. The gaming device of claim 35 further comprising a second actuator located within the housing and in communication with the animated element, the second actuator in communication with the game controller, wherein the second actuator moves at least a portion of the animated element in response to a signal transmitted from the game controller.

37. The gaming device of claim 35 wherein the animated figure comprises a representation of all or part of an animal, bird, human, human-like figure, boat, automobile, or train car.

38. An animated gaming system comprising:
a. a housing, the housing being configured to hold gaming components;
b. a game controller disposed in the housing, the game controller being configured to control game functions and components, present a game to a player, and randomly determine a game outcome;
c. a display area located in the housing;
d. a plurality of prize displays located on the display area displaying game related indicia; and
e. an animated figure located on the display area and comprising:
i. at least one animated element, the animated element being moveable between at least a first and a second position, wherein in at least one position the animated element is proximate at least one prize display, denoting that the prize display has been selected by the animated element;
ii. an actuator located within the housing, coupled to the animated element, and in communication with the game controller, the actuator being configured to move the animated element in response to signals from the game controller, wherein the animated figure can be made to appear to indicate at least one prize display.

39. The animated gaming system of claim 38, wherein the animated figure can be made to appear to indicate at least two prize displays.

40. The animated gaming system of claim 39 wherein one prize display indicated by the animated figure comprises a monetary prize amount and another prize display indicated by the animated figure comprises a multiplier value.

41. The animated gaming system of claim 39 wherein the prize displays indicated by the animated figure are indicated simultaneously.

42. The animated gaming system of claim 39 wherein the prize displays indicated by the animated figure are indicated sequentially.

43. The animated gaming system of claim 38 further comprising a motor controller intermediate to and in communication with the game controller and the animated element, the motor controller located within the housing, the motor controller receiving signals from the game controller and moving the animated element according to the signals received from the game controller.

44. The animated gaming system of claim 38 further comprising a transducer in communication with the game controller and generating sounds as directed by the game controller.

45. The animated gaming system of claim 38 wherein the animated figure comprises a representation of all or part of an animal, bird, human, human-like figure, boat, automobile, or train car.

46. A method for operating an animated gaming device comprising, but not necessarily in the order shown:
a. allowing a player to place a wager and play a game of chance having a random game outcome;
b. determining the random game outcome using a controller;
c. moving at least a portion of a moveable animated figure on a display area of a housing using an actuator in response to a signal received from the controller; and
d. indicating, using the moveable animated figure, a prize display corresponding to the random game outcome.

47. The method of claim 46 further comprising providing a primary game in association with a bonus game, wherein at least steps c-d comprise the bonus game.

48. The method of claim 46 wherein the prize display comprises a monetary amount.

49. The method of claim 46 wherein the prize display comprises a multiplier.

50. The method of claim 46 wherein the display area comprises a changeable background area, further comprising changing images displayed on the changeable background.

51. The method of claim 46 further comprising allowing the player to provide input via a player input device and moving the animated figure proximate a prize display according to the player input.

52. The method of claim 51 wherein the value of indicia appearing on the prize display selected by the player is displayed after the player enters the player input.

53. The method of claim 46 wherein the animated figure comprises a representation of all or part of an animal, bird, human, human-like figure, boat, automobile, or train car 54. The method of claim 46 further comprising indicating at least a second prize display using the animated figure.
